(19) United States
(12) Patent Application Publication
(10) Pub. No.: US 2024/0303255 A1
(43) Pub. Date: Sep. 12, 2024

(54) USING BITSETS TO COMMUNICATE INFORMATION CONCERNING ENTITIES IN A CATALOG

(71) Applicant: NETFLIX, INC., Los Gatos, CA (US)

(72) Inventors: John Andrew KOSZEWNIK, Morgan Hill, CA (US); Val MINAEV, Palo Alto, CA (US); Varun KHAITAN, San Francisco, CA (US); Adam Taro LINDSAY, San Jose, CA (US); Jongyoon LEE, San Ramon, CA (US); Jonathon Peter LEIBUNDGUTH, San Jose, CA (US)

(21) Appl. No.: 18/181,456

(22) Filed: Mar. 9, 2023

(51) Int. Cl. G06F 16/28; G06F 16/22

(52) U.S. Cl. CPC G06F 16/285; G06F 16/2237

(57) ABSTRACT

In various embodiments a computer-implemented method for communicating sets of entities in a content catalog is disclosed. The method includes loading an entity index into memory at a microservice, where the entity index comprises entity identifiers corresponding to titles in a catalog, and where each identifier in the entity index is mapped to an ordinal number. The method also includes composing a message including a bitset to identify titles from the catalog, where a bit in the bitset is set if a position of the bit in the bitset corresponds to a respective ordinal number in the entity index associated with the one or more titles. Additionally, the method includes transmitting the message to a different microservice where a memory for the recipient microservice comprises a copy of the entity index, and where the bitset comprised within the message is decoded into entity identifiers using the entity index.

### BACKGROUND

### Field of the Various Embodiments

The various embodiments relate generally to managing a content catalog and, more specifically, to techniques for efficiently communicating and storing metadata associated with a content catalog.

### Description of the Related Art

Applications associated with a content provider can comprise several microservices communicating with each other. The applications or services in a cloud computing environment (e.g., for a streaming platform) are generally developed and deployed as multiple units, such as a collection of microservices. Microservices (also referred to herein as “services”) or a “microservices architecture” is a software architecture paradigm where various functionality is implemented in software as a suite of independently deployable and cooperating services. The cooperating services run processes and communicate to form an enterprise application. More specifically, in a microservices architecture, an application is developed as a collection of small services; each service implements business capabilities, runs in its own process and communicates via Application Program Interfaces (“APIs”), e.g., hypertext transfer protocol (HTTP) APIs, or messaging. Each microservice may be deployed, upgraded, scaled and restarted independent of other services in the application, typically as part of an automated system, enabling frequent updates to live applications without impacting downstream users.

One of the challenges associated with developing microservices for a content provider (e.g., a streaming platform application) is that the microservices may frequently need to communicate long strings of metadata pertaining to titles or entities between each other. For example, executing queries across the catalog may require transmitting results associated with the query, which includes metadata for potentially thousands of titles or entities in the catalog, between services. By way of further example, a microservice responsible for determining which of the titles in a catalog to display on a screen may need to receive metadata for a large set of entities from a different microservice. Transmitting metadata for large sets of entities between services could require serializing and deserializing sets of entity identifiers for the potentially thousands of titles, which is computationally expensive.

Generalized streaming platforms transmit information pertaining to entities in the catalog in a JAVASCRIPT Object Notation (JSON) format, where the JSON blob includes the entire metadata to be transmitted (e.g., an entity identifier string “video12345678”) for each entity. Accordingly, when transmitting object identifier strings for a given entity in the JSON blob, a total of 208 bits may need to be transmitted (13 characters per string×2 bytes per character×8 bits per byte). Transmitting entire identifier strings for a significant number of entities, as is often needed, can quickly result in inordinately large message sizes and lead to significant scalability challenges.

Generalized content providers also do not provide compression methods that reduce the amount of storage space required to store metadata associated with the catalog in memory. Furthermore, for generalized content providers, performing computations across the catalog (e.g., to execute a query requesting movies in Country A with Spanish subtitles) using strings of metadata associated with the titles can be computationally expensive and inefficient.

As the foregoing illustrates, what is needed in the art are more effective techniques for storing, communicating and querying metadata associated with catalog content.

### SUMMARY

One embodiment sets forth a computer-implemented method for communicating sets of entities in a content catalog. The method includes loading a first index into memory at a first microservice of a plurality of microservices associated with an application, wherein the first index comprises a plurality of entity identifiers corresponding to a plurality of entities in a catalog, wherein each identifier from the plurality of identifiers in the index is mapped to an ordinal number. The method also includes composing, at the first microservice, a message comprising a bitset to identify one or more entities from the catalog, wherein a bit in the bitset is set if a position of the bit in the bitset corresponds to a respective ordinal number in the index associated with the one or more entities. Additionally, the method includes transmitting, from the first microservice, the message to a second microservice of the plurality of microservices, wherein a memory for the second microservice comprises a second index, where the second index is consistent with the first index, and wherein the bitset comprised within the message is decoded into entity identifiers corresponding to the one or more entities using the bitset and the second index.

At least one technical advantage of the disclosed techniques relative to the prior art is that, with the disclosed techniques, the amount of time required to transmit information (e.g., identifiers and other metadata) related to sets of titles or entities in a catalog is substantially reduced. In that regard, the disclosed techniques enable a user to represent a set of entities in a catalog using a bitset representation. Because each microservice in the application comprises an in-memory copy of an index that can be used to decode the bitset back into a set of identifiers associated with the set of entities, prohibitively large messages do not need to be exchanged between the microservices. Additionally, the entire catalog can be represented more efficiently using bitsets. Representing the entire catalog as bitsets not only reduces the size of the messages between services, but also the cost of constructing and interpreting the messages is significantly reduced.

Another advantage of the disclosed techniques is that because the catalog can be represented using bitsets, computations on the catalog can be performed using a fraction of the time (e.g., in sub-milliseconds) relative to prior art techniques. For example, complex query operations can be performed at the granularity of the entire content catalog using bitwise operations that can be performed over a single CPU cycle. The disclosed techniques also allow for highly scalable remote queries across the entire catalog because the resultant bitsets have a low maximum size (regardless of the number of entities contained in the computational results of the queries) and can be transmitted rapidly and efficiently between microservices. Another advantage is that similarities in sets of predicate bitsets can be leveraged to cluster the bitsets and store them much more cheaply and efficiently relative to prior art techniques that did not use bitsets. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments.

FIG. 2 is an example illustration of the manner in which an entity index is used to encode one or more entities in a catalog as a bitset, according to various aspects of the present invention.

FIG. 3 is an example illustration of the manner in which a catalog with multiple entity types can be represented using separate indices for each type, according to various aspects of the present invention.

FIG. 4 is an example illustration of using precomputed bitmasks to perform a complex query related to the content catalog, according to various aspects of the present invention.

FIG. 5 is an example illustration of encoding entity sets that are time sensitive, according to various aspects of the present invention.

FIG. 6A is an example illustration of a simple clustering process used to compress two bitsets, according to various aspects of the present invention.

FIG. 6B is an example illustration of a group of bitsets to be clustered using a simple clustering process, according to various aspects of the present invention.

FIG. 7A provides an example illustration of a clustering process that can be applied to a set of related predicate sets computed across members of a particular group, according to various aspects of the present invention.

FIG. 7B provides an example illustration of a second pass clustering process that can be applied to the clusters created in FIG. 7A, according to various aspects of the present invention.

FIG. 8 is an example illustration of an advanced clustering process that can be applied to a set of related predicate sets computed across members of a group where each member is associated with a different set of available titles, according to various aspects of the present invention.

FIG. 9 is a flow diagram of method steps for transmitting messages pertaining to entities in a catalog using bitsets, according to various embodiments of the present invention.

FIG. 10 is a flow diagram of method steps for clustering a group of bitsets, according to various embodiments of the present invention.

FIG. 11A is a flow diagram of method steps for clustering a group of bitsets computed across members of a group where each member is associated with a different set of available entities, according to various embodiments of the present invention.

FIG. 11B is a flow diagram of method steps for reconstructing a bitset from a compact representation created by the method discussed in connection with FIG. 11A, according to various embodiments of the present invention.

FIG. 12 is a block diagram of a server that may be implemented in conjunction with system 100 of FIG. 1, according to various embodiments of the present invention.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

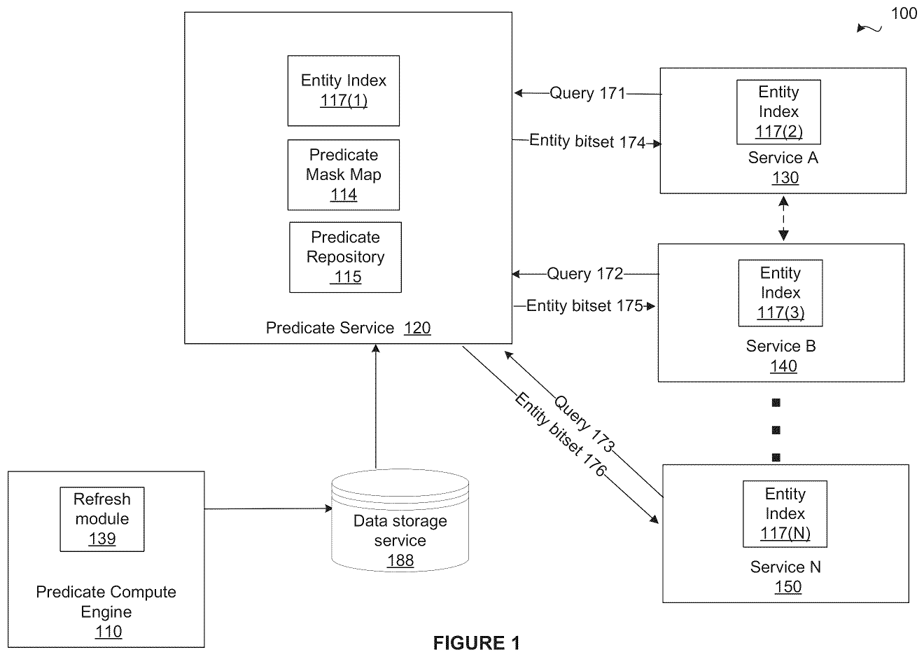

FIG. 1 is a conceptual illustration of a system 100 configured to implement one or more aspects of the various embodiments. As shown, in some embodiments, the system 100 includes, without limitation, a predicate service 120, a data storage service 188 (cloud-based or otherwise), a predicate compute engine 110, a microservice (or “service”) A 130, service B 140 and service N 150. As shown in FIG. 1, each of the services, including service A 130, service B 140, service N 150 and the predicate service 120, comprises a respective entity index 117 (referred to herein as both an “entity index” or “entity lookup table”) (e.g., 117(1), 117(2) . . . 117(N)). For explanatory purposes, multiple instances of like objects are denoted with reference numbers identifying the object and parenthetical numbers identifying the instance, where needed. The predicate service 120 also comprises a predicate mask map 114 and a predicate repository 115. The predicate compute engine 110 comprises a refresh module 139. In some other embodiments, the system 100 can include any number and/or types of other compute instances, other display devices, other databases, other data storage services, other services, other compute engines, other input devices, output devices, input/output devices, search engines, or any combination thereof.

Any number of the components of the system 100 can be distributed across multiple geographic locations or implemented in one or more cloud computing environments (e.g., encapsulated shared resources, software, data) in any combination. In some embodiments, the services (e.g., services 120, 130, 140, 150, etc.) and compute engines (e.g., compute engine 110) can be implemented in a cloud computing environment, implemented as part of any other distributed computing environment, or implemented in a stand-alone fashion.

As described in greater detail previously herein, one of the challenges associated with developing microservices for a content provider (e.g., a streaming platform application) is that the microservices may frequently need to communicate information or metadata pertaining to titles or entities in the content catalog associated the streaming platform between each other. For example, service A 130, which can comprise a recommendation producing engine, may need to send a set of titles to service B140, which can comprise a display engine, to display the titles on a graphical user interface. Transmitting metadata including entity identifiers for a large number of entities between services A and B could involve serializing and deserializing sets of entity identifiers for potentially thousands of titles, which is both computationally expensive and results in inordinately large message sizes, thereby, leading to significant scalability challenges.

### Entity Set Representation Using Bitsets

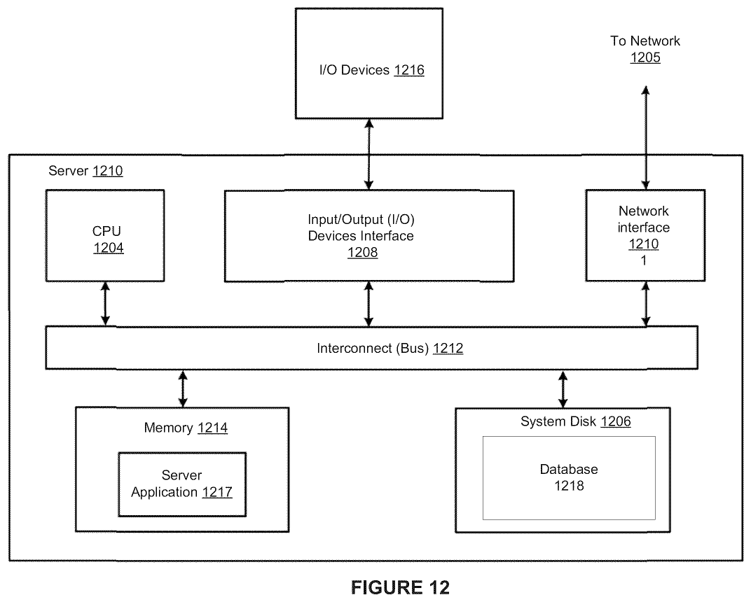

To address the above problems, the system 100 includes, without limitation, an entity index 117 in each service (e.g., service A 130, service B 140, predicate service 120, etc.) associated with an application for the content provider or streaming service. The entity index 117 can be stored in non-volatile memory on a server (or servers) on which a respective service executes (as discussed further in connection with FIG. 12) and can be loaded into volatile memory during system start-up or when a respective service launches.

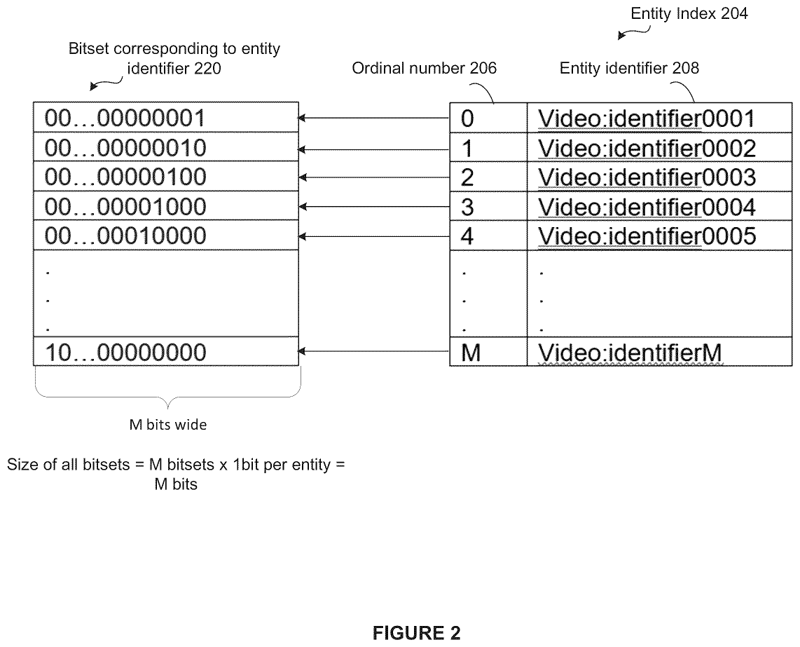

FIG. 2 is an example illustration of the manner in which an entity index is used to encode one or more entities in a catalog as a bitset, according to various aspects of the present invention. In some embodiments, in order to represent entities in a catalog more efficiently, each element or entity in a catalog is assigned an ordinal number in a compact space (also referred to herein as an “ordinal space”) between [0-M], where M is the number of possible elements. FIG. 2 illustrates an example entity index 204 in which each entity identifier 208 is mapped to (or assigned to) a respective ordinal number 206. For example, a video entity with entity identifier “Video:identifier00001” is mapped to ordinal number “0,” while a video entity with entity identifier “Video:identifier00002” is mapped to ordinal number “1.” Each ordinal number 206 indicates a bit position in a bitset 220 that corresponds to the respective entity identifier 208. For example, ordinal number “2” in the entity index 204 indicates that the third position in the bitset corresponds to entity identifier “Video:identifier0003,” while ordinal number “3” in the entity index 204 indicates that the fourth position in the bitset corresponds to entity identifier “Video:identifier0004.” Because each entity is assigned to a dedicated position in the bitset, information about one or more entities can be communicated easily between services using just the bitsets so long as each service has a local copy of the entity index 204 in its memory to be able to decode the bitset. Further, because each entity is assigned to a dedicated bit position in the bitset, the width of the bitset can, in some embodiments, be equal to the number of entities in the entity index 204. For example, in the example of FIG. 2, there are M entity identifiers in the entity index 204 and, accordingly, a bitset that is M bits wide is needed to represent all the bitsets. By assigning an ordinal number to the various entities in a catalog, where the ordinal numbers represent a position in a bitset, compact in-memory representations of an entire catalog can be created.

As explained above, transmitting entire entity identifiers between services would involve transmitting messages that are inordinately large because several bits are needed to communicate the metadata or identifiers for each entity (e.g., at least two bytes can be needed to transmit each character in the identifier where each identifier can be several characters long). By comparison, communicating information related to a set of entities using the scheme illustrated in FIG. 2 involves transmitting a bitset that has a maximum size of M bits. For example, if an example recommendation service A 130 in FIG. 1 had to communicate to a display service B 140 that entities “Video:identifier0002,” “Video:identifier0004” and “Video:identifier0005” are to be displayed on a user interface, instead of transmitting the entire entity identifier strings for the respective entities from service A 130 to service B 140, service A 130 would use its copy of the entity index (e.g., entity index 117(2) as shown in FIG. 1) to determine the ordinal numbers corresponding to the earlier referenced identifiers. For example, ordinal number “1,” “3” and “4” correspond to the entity identifiers that need to be communicated to service B 140. Using the ordinal numbers “1,” “3” and “4,” service A 130 can encode the entity identifiers as a M-bit wide bitset, “00 . . . 00011010,” where bit positions 1, 3 and 4 in the M-bit wide bitset are set to indicate the presence of the respective entities in the bitset. Thereafter, instead of sending the entity identifier strings for each of the relevant entities, service A 130 can simply transmit the bitset “00 . . . 00011010” to service B 140.

It should be noted again that each service (including service A 130 and service B 140) typically has a local copy of the entity index 204 in order to be able to decode any incoming bitsets received from other services. The local copy of the entity index 204 will typically stay consistent across each of the services in the application. Staying consistent involves the entity identifiers and the corresponding ordinal numbers being ordered in the same manner in the various copies of the entity index across the application. The local copy of the entity index 204 at each service functions as a pre-distributed dictionary that can be used to encode and decode the bitsets. Because a local copy of the entity index is used at each service to decode bitsets representing entities and represents a shared state between the various services associated with the application (for the streaming platform), the communication scheme is considered stateful. Accordingly, when service B 140 receives the bitset, service B can efficiently decode the bitset using a local copy of the entity index 204 (e.g., 117(3) as shown in FIG. 1). In this way, the underlying entities represented by any given bitset are determinable based on an index that is shared between each service. As a result, a message that could potentially be several megabytes long, depending on the size of the catalog, can be reduced in size to a few kilobytes.

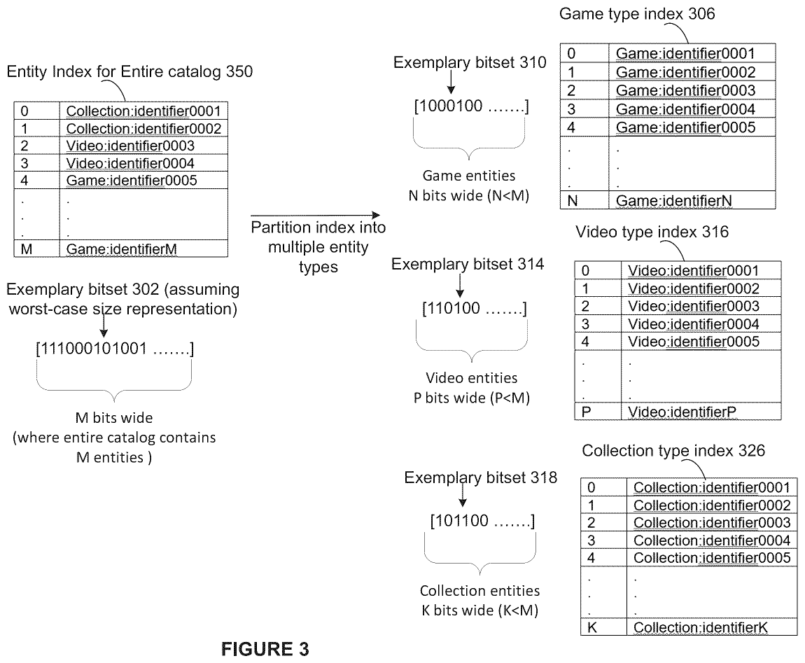

FIG. 3 is an example illustration of the manner in which a catalog with multiple entity types can be represented using separate indices for each type, according to various aspects of the present invention. Typically, a content catalog will include more than a single type of content. For example, a streaming platform may have multiple different types of content including games, video, episodes, seasons, collections, and top nodes (where a top nodes represents the highest node in a tree of entities containing episodes of a given show). The illustration in FIG. 3 shows an entity index 350 that can comprise many different types of content, including collections, videos, games, etc. in the catalog. In some embodiments, the entity index 350 can include all the titles for various different types of content using a single ordinal space [0-M]. However, catalogs for various content providers and streaming platforms can include millions of titles. Representing millions of titles with a single bitset is often not optimally efficient. For example, if a catalog contains 1.2 million different titles (of all types), a bitset to represent all the titles would need to be at least 150 kilobytes (1.2 million titles/8 bits per byte). As shown in FIG. 3, if M=1.2 million titles, an example bitset 302 to represent the entire catalog would be 1.2 million bits wide.

In some embodiments, instead of representing all the different types of entities using a single ordinal space, each type of content is represented using a separate ordinal space. As shown in FIG. 3, a separate entity index can be maintained for each type of content, including games, video and collections. Note that the illustration in FIG. 3 is merely an example and that, in addition to the types shown in FIG. 3, there may be several additional types of entities with their own respective ordinal spaces (e.g., top nodes, episodes, movies, etc.). Partitioning the compact space [0-M] into multiple entity types results in higher density sets. Because most of the queries between services or otherwise will relate to specific entity types, maintaining a separate index or lookup table for each entity type results in great efficiency. For example, for a streaming platform, the available content displayed to a user through a graphical user interface typically comprises separate rows for each type of content. Most of the queries and entity sets needed to be processed and communicated between services to create this display will involve addressing different types of entities separately. For example, episode related entities will need to be addressed separately from, for example, movie or game entities. Separating out the entity types into dedicated ordinal spaces for each type also allows developers of the services to work exclusively with the part of the catalog most pertinent to their project or task. Separating out the types prevents unnecessary bits being communicated that relate to types that are not being referenced in a particular communication. For example, if the entire catalog was represented using a single M-bit wide bitset (e.g., bitset 302 in FIG. 3), queries related exclusively to videos would involve a large number of ‘0’s in the bitset being transmitted for all other types. Separating out the types into dedicated ordinal spaces prevents additional ‘0’s from being transmitted related to types that are not addressed in a particular communication between services. Instead, a NULL value can be transmitted for types that are not relevant to a particular transmission.

As shown in FIG. 3 then, a game type index 306 with a total of N entities can be maintained for gaming related entities, where N is less than the total number of entities in the catalog, M. An example bitset 310 corresponding to the game type index 306 will accordingly be N bits wide. Because gaming related entities are partitioned into their own space and an N-bit wide bitset will be significantly narrower than a M-bit wide bitset (assuming that games do not comprise a significant proportion of the catalog), the worst case message or bitset size to transmit information related to gaming entities will be narrower than if the entire catalog was represented using a single contiguous index.

As shown in the example of FIG. 3, a video type index 316 with a total of P entities can be maintained for video related entities, where P is less than the total number of entities in the catalog, M. An example bitset 314 corresponding to the video type index 316 will accordingly be P bits wide. Because video related entities are partitioned into their own space and a P-bit wide bitset will be significantly narrower than a M-bit wide bitset (assuming that videos do not comprise a significant proportion of the catalog), the worst case message or bitset size to transmit information related to video entities will also be narrower than if the entire catalog was represented using a single contiguous index.

As shown in the example of FIG. 3, a collection type index 326 with a total of K entities can be maintained for collections related entities, where K is less than the total number of entities in the catalog, M. An example bitset 318 corresponding to the collections type index 326 will accordingly be K bits wide. Because video related entities are partitioned into their own space and a K-bit wide bitset will be significantly narrower than a M-bit wide bitset (assuming that collections do not comprise a significant proportion of the catalog), the worst case message or bitset size to transmit information related to collection entities will be narrower than if the entire catalog was represented using a single contiguous index. Partitioning the catalog into separate entity types allows the entire set of entities in the catalog to be effectively represented as a list of bitsets. For example, referencing FIG. 3 again, the entire set of entities within the catalog of size M can be effectively represented as a list of bitsets comprising bitset 310 of size N, bitset 314 of size P and bitset 318 of size K.

### Predicate Bitsets

As mentioned earlier, one advantage of the disclosed techniques is that, because the catalog can be represented using bitsets, computations on the catalog can be performed using a fraction of the time (e.g., in sub-milliseconds) relative to prior art techniques. Generalized content delivery systems often need to perform complex computational operations on the entity identifiers or metadata that is typically stored in string formats. By comparison, representing sets of entities using bitsets allows embodiments of the present disclosure to perform computationally simple Boolean operations (e.g., AND, OR, XOR, etc.) across the bitsets. Performing operations on strings can involve several clock cycles and be computationally expensive. Comparatively, Boolean computations using bitsets can be performed, for example, using a single CPU register operation. In fact, embodiments according to the present disclosure allow the entire catalog to be filtered using a single Boolean operation.

In some embodiments, predicate bitsets (also referred to herein as “precomputed bitset masks”) that represent pertinent logic for the content provider can be pre-constructed and stored in memory to, among other things, provide efficient responses to queries. For example, certain sets or categories of entities may need to be referenced on a recurring basis because they represent salient categories of content available in a catalog or to be delivered to subscribers of a streaming platform. Examples of different sets of entities that may be important from both a developer or a subscriber perspective can include, but are not limited to, a set of entities ready to display on a website for the streaming platform, a set of entities available in a given country, a set of entities with subtitles in a particular language, a set of entities that are playable on a particular device type, a set of entities related to a particular genre (e.g., romantic comedies, thrillers, etc.), a set of entities playable with a particular membership plan, etc. Precomputed bitset masks that represent these different sets of entities can be preconstructed and stored for later access. Further, the precomputed bitmasks can also be used to respond to complex queries by performing logical operations across the various bitmasks. In some embodiments, each microservice in system 100 in FIG. 1 (e.g., services 120, 130, 140, etc.) is able to create and store bitsets that can be later used as precomputed bitmasks. In some embodiments, the predicate service 120 receives the precomputed bitmasks from the data storage service 188 and stores them in predicate repository 115, from where the predicate sets can be retrieved to perform computations in response to queries.

Each of the microservices stores the same copy of the entity index and, accordingly, the bitsets across all the microservices can be aligned and decoded in a consistent manner. As a result, computational operations can be performed across the entire catalog on bitsets from multiple different services because each position in a bitset from any given service is associated with the same entity or title. For example, bit positions in a bitset from a service that recommends videos of a particular genre will refer to the same entities as respective bit positions in a bitset from a service that determines which videos are accessible in a given country. As a result, computations can be efficiently performed across bitsets from several different services without needing to rearrange the order of the bits in a bitset. The resultant bitsets generated by the computations can then be used in conjunction with the entity index (stored locally at each service) at any service to decode the bitsets and retrieve the entity identifiers referred to by the set bits in the respective bitsets.

In some embodiments, in order to keep the type spaces (ordinal spaces for the various entity types) compact, when an entity identifier changes or is removed from the shared state (e.g., the shared entity index) between the various services, the position for that particular entity identifier will eventually be reused. However, upon removal, an identifier's position will remain unfilled for a predetermined period of time (e.g., on the order of 1 day, 1 week, 1 month, or more) in order to ensure the validity of the various created bitsets circulating within the application and to ensure consistency for a given period of time between the various copies of the entity index maintained by the different services. In some embodiments, the position for the entity identifier that needs to be removed is reserved for a predefined period of time (instead of being recycled right away). The predefined period of time is selected so that a duration of time for which a bitset representation, once constructed, will be guaranteed usable. Defining a period of time for which a bitset representation is guaranteed to be usable allows for both eventual consistency of the shared state index across services and also enables caching of the bitsets with a known expiry.

Referring back to FIG. 1, the precomputed bitset masks or predicate bitsets can be precomputed by the predicate compute engine 110. The predicate compute engine 110 can, in some embodiments, read data from the entire content catalog or system and be programmed to precompute various predicate bitsets of particular interest to application developers (or subscribers of the streaming platform). The predicate bitsets can be clustered together and compressed (as will be explained in further detail below) to be uploaded to the data storage service 188 in the cloud computing environment. In some embodiments, the predicate compute engine 110 comprises a refresh module 139 that loads newly available data from the content catalog on a periodic basis and performs the computations to determine new predicate sets (or update the existing ones) prior to compressing and uploading the predicate sets to the data storage service 188.

In some embodiments, a dedicated service, for example, the predicate service 120 is used to store and perform Boolean operations using the predicate sets related to various different categories of entities (e.g., bitsets related to titles available in particular countries, bitsets related to different genres, etc.) that are computed by the predicate compute engine 110. Representing categories of entities as bitsets in accordance with embodiments of the present disclosure also allows a multitude of different types of lists of predicate sets (e.g., lists of predicate sets associated with different countries, genres, maturity levels, permission levels, subscription levels, etc.) to be stored efficiently using bitsets. Generalized content providers by comparison store various lists of entities using entity identifiers, which required a prohibitive amount of storage space. Storing the lists of entities as lists of bitsets instead reduces the storage space needed for the lists of entities by several orders of magnitude.

Storing various groups or categories of entities as predicate sets also enables the predicate service 120 to respond to complex queries from other services associated with the application for the streaming platform at runtime. In some embodiments, at system startup or during a service launch phase, the predicate service 120 can download the set of compressed predicates from the data storage service 188 and load the set of predicates into memory (e.g., in volatile memory in a predicate repository 115). The manner in which the compressed predicates downloaded from the storage service 188 are decompressed will be discussed in greater detail below.

Storing predicate sets in the predicate service 120 allows services (e.g., service A 130, service B 140, service N 150) to transmit complex queries (e.g., query 171, query 172, query 173, respectively) to the predicate service 120 and receive responsive entity bitsets (e.g., responsive entity bitset 174, responsive entity bitset 175, responsive entity bitset 176, respectively), where the responsive entity bitsets are computed using the predicate bitsets by predicate mask map 114. In some embodiments, the dedicated predicate mask map 114 performs the logical operations to compute the results based on bit logic received from other services as part of a query. The predicate service 120 computes responses to queries received from other services using a Boolean operation between precomputed bitmasks stored in the predicate repository 115.

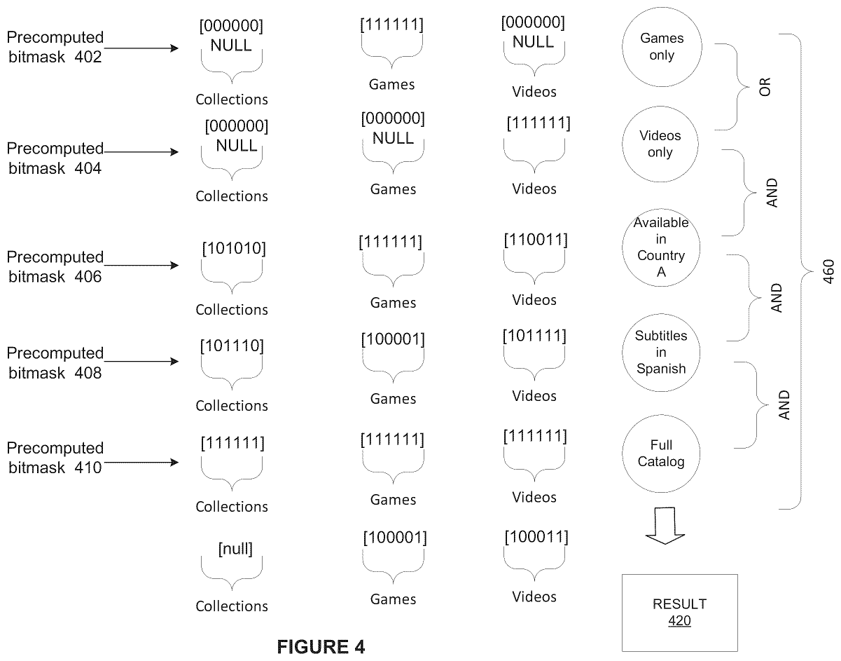

FIG. 4 is an example illustration of using precomputed bitmasks to perform a complex query related to the content catalog, according to various aspects of the present invention. As indicated above, using bitsets to represent lists of entities allows complex queries to be performed across the entire catalog efficiently. For example, a single computation of an entity set expression can take as little as 0.1% of 1 ms. As shown in the example of FIG. 4, the predicate service 120 may receive a query comprising the entity set expression 460, which requests games or videos that are available in the content catalog in Country A and have subtitles in Spanish.

To compute a response to the query, the predicate mask map 114 in FIG. 1 accesses the set of predicates stored in the predicate repository 115. The predicate repository can, for example, store a precomputed bitmask 406 for the set of entities in the catalog available in country A (including entities for the various entity types such as games, videos and collections), a precomputed bitmask 408 for the set of entities in the catalog with Spanish subtitles, and a precomputed bitmask 410 for all titles available in the catalog. As mentioned earlier, each entity type can be represented using a dedicated ordinal space with NULLs stored for the other entity types. Accordingly, a precomputed bitmask 402 for the games entity types will comprise set (or asserted) bits for all gaming related entities and a NULL value will be stored corresponding to other entity types. Similarly, a precomputed bitmask 404 for the videos entity types will comprise set bits for all video related entities and a NULL value will be stored corresponding to other entity types. Note that for precomputed bitmasks 402 and 404, which represent all the entities available for a particular entity type, all the bits corresponding to the respective entity type will be set to ‘1.’ Similarly, for precomputed bitmask 410, which represents the universe of available titles in the catalog, the bitmask will comprise all set bits. Because not all titles in a catalog will be available in Country A or have Spanish subtitles, precomputed bitmasks 406 and 408 will have both asserted and unasserted bits. The predicate mask map 114 can deliver a result 420 to the entity set expression 460 using a single CPU cycle by performing the necessary Boolean operations across the various precomputed bitmasks. Note that while a narrower bitmask size has been selected for illustration purposes in FIG. 4, an actual catalog can comprise millions of entities resulting in much wider bitmask sizes than the example ones illustrated in FIG. 4.

### Gap Encoding

In some embodiments, bitsets can be compacted even further when stored or communicated between services. For example, certain bitsets may contain several unasserted bits (or zeroes). Such bitset representations will typically contain long strings of zeroes which provide opportunities for compression. In order to reduce the cache and message size of entity sets, in some embodiments, a gap encoding methodology for encoding such bitsets can be provided that will result in a more compact representation for the bitsets. Gap-encoding sparse bitsets typically comprises using up to, for example, 2-byte short words to encode positive integers that represent positions of the set bits in the bitset.

For example, an example 40-bit bitset “000 . . . 000100100” contains only two asserted bits in bit-positions 35 and 38 (counting from left to right) with the rest of the bitset containing zeroes. The example bitset can be gap-encoded so that instead of storing or transmitting the entire 40-bit bitset, the set bits in the sparse set can be gap-encoded with a string of variable-length encoded values. The encoding can, for example, encode positive integer values using up to 2-byte short words, where the positive integer values can be encoded using either one or two words (e.g., values up to 0x7FFF can be encoded using one word, otherwise two words). The precise position of the first set bit (counting from left to right) in the bitset can be encoded as part of the gap-encoded compact representation. Thereafter, the gap between each subsequent bit can also be encoded as part of the compact representation. For the bitset in the current example above, the entire bitset can be represented using two positive integer values corresponding to the two set bits as follows: {35, 3}, where 35 is the bit position of the first set bit and 3 is the gap between the first set bit and the second set bit. Representing the gap between the set bits instead of the actual bit position for each subsequent bit after the first one allows the representation to be even more compact. Using gap-encoding to compress sparse bitsets results in relatively more efficient storage and communication of the bitsets.

### Temporal Entity Sets

Not all precomputed catalog entity states can be represented using only a single bitset. Some attributes are time-sensitive and depend on the exact moment of the call from one service to another. For example, the set of titles currently present within an exhibition window can change frequently and, accordingly, an entity set associated with the set of titles present within an exhibition window can be time-sensitive. Similarly, the set of available titles can also be time-sensitive. In such cases, the state of the catalog at a given moment can be represented with a bitset, but the entities within the set represented by the bitset may vary frequently over time. These type of time-dependent bitsets (also referred to herein as “temporal predicate sets” or “temporal entity sets”) need to be encoded to include information regarding the flips (e.g., a change in a bit from unasserted to asserted or from asserted to unasserted) in the bitset over a predetermined period of time in the future.

In some embodiments, for a temporal predicate set, a base bitset representing a state of the catalog is computed by the predicate compute engine 110 (shown in FIG. 1). The base bitset represents the state of the catalog at time t=0. In some embodiments, the future state of the catalog for a predetermined amount of time can be encoded along with the base bitset so that a representation of the catalog state that is as accurate as possible can be determined at any given time. For example, the state of the bitset up to one week in the future can be encoded along with the bitset.

In some embodiments, where entities are known to (or likely to) experience a flip in their state, a timestamp, which is offset from the moment of precomputation in accordance with a predetermined resolution (e.g., a one minute resolution) is encoded as, for example, a 2-byte short value. In addition to recording the timestamp, a gap-encoded mechanism similar to the one described above using 2-byte short words can be used to reference the ordinal numbers associated with the bits that will flip during the predetermined time period (e.g., one week into the future). Accordingly, the encoding scheme involves tracking the base bitset, a timestamp for each time a bit in the base bitset flips and a list of bits that flip at a corresponding timestamp.

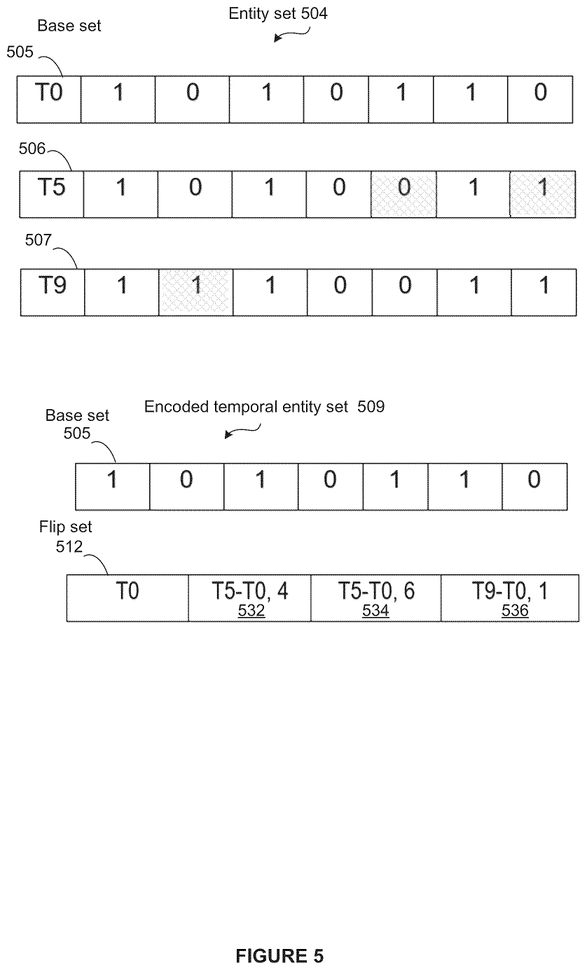

FIG. 5 is an example illustration of encoding entity sets that are time sensitive, according to various aspects of the present invention. FIG. 5 illustrates an entity set 504 that will fluctuate over time. Base bitset 505 represents the state of the entity set at time t=0, bitset 506 represents the state of the entity set at time t=5 and bitset 507 represents the state of the entity set at time t=7. Base bitset 505 represents the base entity set at the time of precomputation by the predicate compute engine 110 (shown in FIG. 1).

As shown in FIG. 5, for bitset 506 corresponding to time t=5, bit positions 4 and 6 (scanning the bitset from left to right where the first bit corresponds to bit position 0) are flipped respective to the base bitset. Similarly, for bitset 507 corresponding to time t=9, bit 1 is flipped respective to the base bitset. As noted above, in some embodiments, the future state of the catalog for a predetermined amount of time (e.g. one week) can be encoded using a temporal entity set which includes the base bitset along with additional information regarding the manner in which the base bitset is going to fluctuate over time. The additional information can, in some embodiments, include ordinal timestamps for times when a flip in at least one of the bits in the base bitset will occur along with a list of bits that will flip for a respective timestamp.

The example encoded temporal entity set 509 shown in FIG. 5 will include the base bitset 505. The encoded temporal entity set 509 will also include a flip set 512. The flip set 512 (also known as a “temporal exception list”) records the timestamps along with a list of bits that flipped at each timestamp. For example, entries 532 and 534 record the timestamp and the ordinal numbers (e.g., bit positions 4 and 6) that flip at time t=5. Further, the flip set entry 536 records the timestamp and the ordinal number (e.g., bit position 1) that flips at time t=9.

In some embodiments, the process of decoding an encoded temporal entity set (e.g., encoded temporal entity set 509) for inclusion in a query (or otherwise) comprises creating a copy of the base set (e.g., base bitset 505) and iterating through temporal exception list (e.g., flip set 512), flipping the indicated bits until the decode time is greater than the closest timestamp immediately prior to the decode time.

For example, if the encoded temporal entity set 509 is read at time t=6, then the decode process starts with the base bitset 505 and iterates through the flip set 512 until the read time is greater than the last available timestamp encoded into the flip set 512. Accordingly, the decode process will read the entries 532 and 534 in the flip set 512 and flip the corresponding bits in the base bitset 505. The decode process, however, will not progress on to the entry 536 in the flipset because the read time, t=6, is less than the timestamp encoded into the entry 536. If, however, the read process is performed at time t=11, the read process will iterate through the entire flip set 512 flipping all the bits indicated by the entries 532, 534 and 536 to retrieve the most accurate representation of the bitset at time t=11.

In some embodiments, a similar process can also be used to encode changes in an entity set over time. For example, in some cases, it may be necessary to retain changes to an entity over a given period of time (e.g., one month) with a given resolution (e.g., 10 minutes). In some embodiments, these changes can be encoded as lists of, for example, one or two byte short words. More specifically, the encoding process, in some embodiments, would encode the number of intervals in which changes occur. Then, for each interval, a timestamp value can be encoded to record the moment of change followed by the number of bits to flip and a gap-encoded list of bits to flip

### Clustering Entity Sets

As noted previously, generalized content providers do not provide compression methods that can significantly reduce the amount of storage space needed to store metadata, including entity identifiers, associated with the catalog in memory. Representing sets of entities in a catalog as bitsets advantageously allows compression techniques to leverage similarities between bitsets in order to cluster them together. Referring to FIG. 1, the predicate compute engine 110 can typically compute thousands of predicate sets that are refreshed periodically (e.g., every 10 minutes) by the refresh module 139. Because these predicate sets need to be uploaded to the data storage service 188, which is typically located in the cloud, leveraging similarities between the predicate sets to cluster them reduces both the storage space needed for the predicate sets and also the time to upload the predicate sets to the cloud.

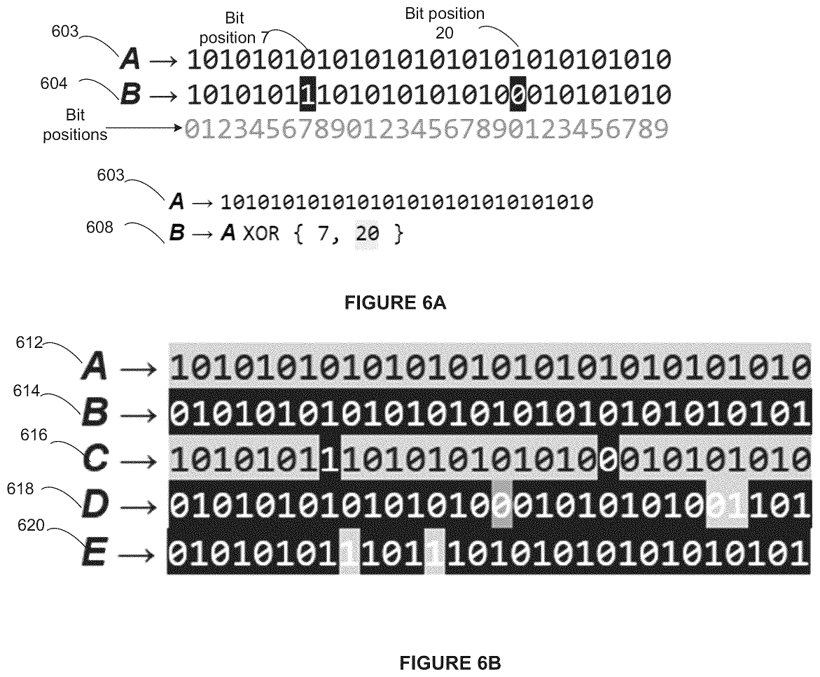

FIG. 6A is an example illustration of a simple clustering process used to compress two bitsets, according to various aspects of the present invention. As noted above, bitsets that are similar can be clustered together so that one or more of the bitsets in the cluster can be stored as a sparse set, where a sparse set is a compact representation of a full bitset. Instead of including all the bits of the bitset, a compact representation typically includes positive integers representing bit positions in the bitset that are flipped relative to the reference bitset (e.g., which, as will be discussed in detail below, is usually a cluster center). In other words, the compact representation conveys the difference between a bitset and the reference bitset. The sparse set can be used in conjunction with another bitset in the cluster known as the cluster center to reproduce the full bitset corresponding to the sparse set. As shown in FIG. 6A, bitsets A 603 and B 604 can be clustered together because the two sets differ by only two elements (e.g., bit positions 7 and 20). To cluster bitsets A 603 and B 604 together, bitset A 603 can be stored in its entirely in the cluster and serves as the cluster center. Bitset B 604, meanwhile, can be clustered together in a same cluster as bitset A 603, and can be represented using: a) a reference to bitset A 603; and b) a sparse set containing the difference between bitset A 603 and bitset B 604. As shown in FIG. 6A, the resultant cluster comprises bitset A 603 and a sparse set B 608. The sparse set B 608 comprises a reference to bitset A 603 and integer values for bits that are flipped (referred to herein as the “flip bits”) with respect to the cluster center, bitset A 603. In some embodiments, in order to reconstruct B on demand, the sparse set B 608 can be applied to bitset A 603 as an XOR operation. Because the sparse sets comprise fewer bits than the entire bitset, clustering not only accomplishes storage space savings but also reduces the time and bandwidth needed to transmit predicate sets (e.g., the time and bandwidth needed by the predicate service 120 to download the predicate bitsets from the data storage service 188).

In some embodiments, the ordinal numbers in the sparse set can be gap encoded so that any integer after the first bit position stored in the sparse set represents a gap from a prior set bit. This results in additional storage savings. For example, referencing the example in FIG. 6A again, instead of encoding the actual bit position for bit 20, the sparse set could simply encode the gap from the prior set bit at bit position 7. Encoding the gap instead of the actual bit position would result in the following sparse set: {7, 13}.

FIG. 6B is an example illustration of a group of bitsets to be clustered using a simple clustering process, according to various aspects of the present invention. A clustering process involving multiple bitsets typically involves finding and designating cluster centers. As discussed in connection with FIG. 6A above, cluster centers comprise bitsets that are not themselves compressed into a compact representation, but can be used to represent other similar bitsets as sparse sets.

Where multiple bitsets are involved, the clustering process also involves defining a minimum threshold distance that is acceptable for a cluster. The minimum threshold distance computation is used to evaluate whether a bitset is similar enough to a cluster center to be eligible for clustering with the cluster center. The value of the minimum threshold distance can, in some embodiments, be the maximum cardinality (or maximum number of set bits) of a sparse representation of a clustered bitset. In other words, a bitset may be ineligible for clustering with a cluster center if the maximum number of set bits for the sparse representation of that bitset would be above this predefined maximum cardinality.

Having defined the minimum threshold distance, the clustering process can begin by iterating over the entire set of predicate sets. The list of cluster centers will initially be empty as the process begins. In some embodiments, when the cluster center list is empty, the first bitset iterated over can be selected as the cluster center as a starting point for the clustering process. Each subsequent bitset iterated over can be compared to the cluster center to calculate the distance between the bitset and the cluster center using, for example, the cardinality of the XOR of the two bitsets (which, as explained above, is the number of set bits in a bitset resulting from the XOR of the two bitsets). If the distance so computed is below the predefined threshold, then that bitset can be clustered with the cluster center and be represented with a reference to the cluster center and a sparse set comprising the flip bits using the techniques discussed in conjunction with FIG. 6A.

Referring back to the example of FIG. 6B, assuming the minimum threshold distance is defined to be 5, the clustering process starts with selecting or designating bitset A 612 as the cluster center since the list of cluster centers is empty initially. The clustering process then iterates over bitset B 614, which is compared to bitset A 612. To compare bitset B 614 with bitset A 612, the two bitsets can be XOR-ed to determine the cardinality of the XOR. Because bitset B 614 is a complement of bitset A 612, the distance is 30 (the size of the entire bitset). Accordingly, bitset B 614 is not eligible for clustering with bitset A 612 because the distance exceeds the predefined value of 5.

Further, because there are no other cluster centers defined for the group of bitsets shown in FIG. 6B, bitset B 614 is added to the list of cluster centers. The clustering process then iterates over bitset C 616 and first computes the distance between bitset C 616 and bitset A 612, the first cluster center in the list. The distance between bitset C 616 and bitset A 612 is 2 and, accordingly, bitset C 616 is eligible to be clustered with bitset A 612. It should be noted that sets within the same cluster are distinguished by a shared highlighting in FIG. 6A. Further, flip bits are also distinguished using a different highlighting than the matching bits.

Thereafter, the clustering process iterates over bitset D 618. The distance between bitset A 612 and bitset D 618 is 27, so the two bitsets are determined not to be a match for clustering. The distance between bitset D 618 and bitset B 614, however, is determined to be 3 and, accordingly, bitset D 618 joins the same cluster as bitset B 614.

Finally, the clustering process iterates over bitset E 620. The distance between bitset A 612 and bitset E 620 is 28, so the two bitsets are determined not to be a match for clustering. The distance between bitset E 620 and bitset B 614 however, is determined to be 2 and, accordingly, bitset E 620 joins the same cluster as bitset B 614. As noted above in reference to FIG. 6A, the sparse sets can be used in conjunction with the referenced cluster center to recreate the original bitset (e.g., by XOR-ing the flip bits).

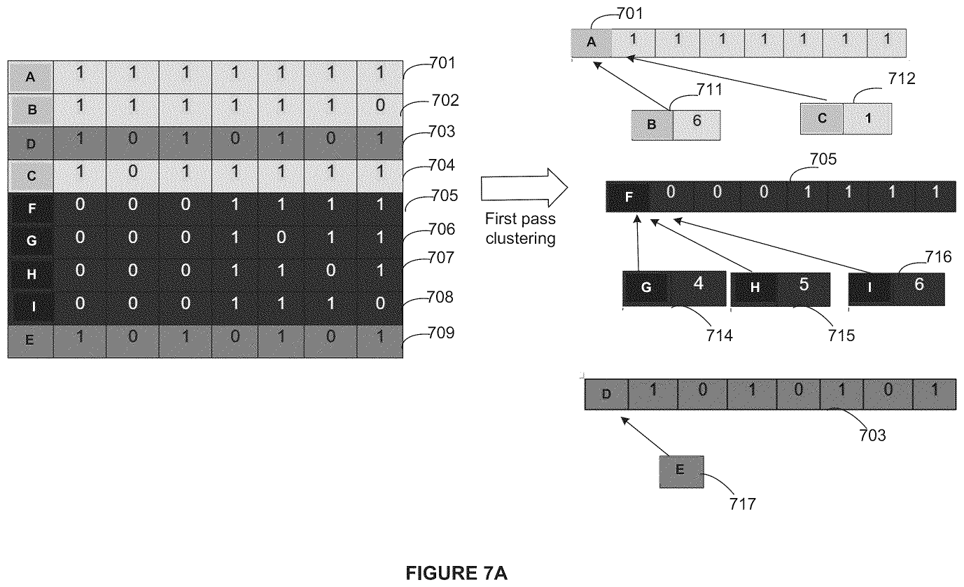

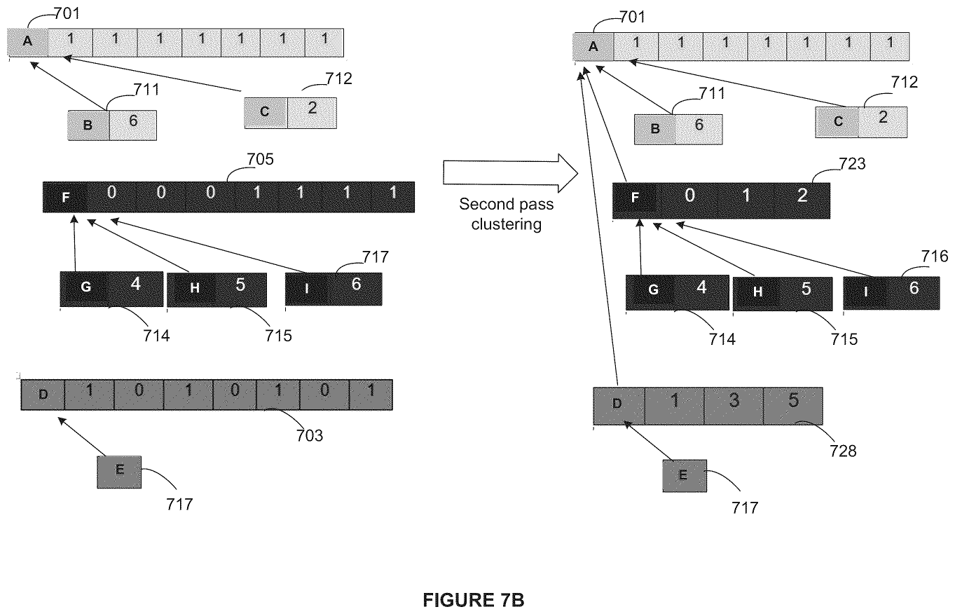

FIGS. 7A and 7B provide an example illustration of a clustering process that can be applied to a set of related predicate sets computed across members of a particular group, according to various aspects of the present invention. As mentioned earlier, the clustering process can be better suited for operating on bitsets that possess some similarities. In some instances, certain predicate sets created for members of a given group associated with a content provider may possess similarities with similar predicate sets created for other members of the given group. The similarities between related predicate sets across members of a particular group makes such groups of related predicate sets particularly conducive for clustering.

The availability of content on streaming platforms, for example, varies from country to country due to licensing agreements with the content creators and distributors. Content providers or streaming platforms have to obtain separate rights for each country, and these rights can have different restrictions and expiration dates, leading to differences in the content available in each region. Although there are differences in content available in each country, certain precomputed bitmasks (e.g., computed by the predicate compute engine 110) for one country may contain several similarities with related precomputed bitmasks for other countries. For example, despite the differences in content across countries, predicate sets related to the set of titles with Spanish subtitles will be fairly similar across all countries. Or, for example, the set of titles that are appropriate for children under 12 years of age will typically be very similar for each country. Accordingly, such predicate sets across the various countries can be clustered together efficiently because the distance between the sets will typically be under a predefined minimum threshold distance. In some embodiments, the clustering process can be performed by the predicate compute engine 110 in FIG. 1.

Referencing FIG. 7A again, an example clustering of predicate sets across various countries is shown. While narrower sized bitsets are used for example purposes in FIG. 7A, it should be noted that the size of the predicate bitsets can depend on the catalog size. The example predicate bitset being clustered across the various countries represented in FIG. 7A can, for example, represent titles with Spanish subtitles, titles with a maturity level over 18, or any other logic pertinent to developers and users of the streaming platform. In some embodiments, each country-specific predicate set can be grouped across all countries into a single group and the clustering process can execute on all members of that group. For example, predicate sets for movies with French subtitles for each respective country (from a possible set of, for example, 250 countries) can be grouped together and the clustering process can be executed across all the members of that group. In some embodiments, a clustering process similar to the one discussed in connection with FIG. 6B can be used in conjunction with the bitsets shown in FIG. 7A.

Bitset 701 is a predicate set associated with Country A, bitset 702 is a predicate set associated with Country B, bitset 703 is a predicate set associated with Country D, bitset 704 is a predicate set associated with Country C, bitset 705 is a predicate set associated with Country F, bitset 706 is a predicate set associated with Country G, bitset 707 is a predicate set associated with Country H, bitset 708 is a predicate set associated with Country I and bitset 709 is a predicate set associated with Country E. Because the Country B bitset 702 and the Country C bitset 704 are closest in distance to Country A bitset 701, the Country B and Country C bitsets are encoded as sparse sets 711 and 712 respectively with the Country A bitset 701 selected as the cluster center. As explained above, the sparse sets 711 and 712 comprise integer values for the flip bits. In some embodiments, the Country A bitset 701 may be selected as the cluster center because it is the first bitset iterated over by the clustering process. In other embodiments, however, the Country A bitset 701 may be selected as the cluster center based on some other programmatic criteria that selects, for example, the optimal cluster centers. It should be noted that sets within the same cluster are distinguished by a shared highlighting in FIG. 7A.

The Country F bitset 705 and the Country D bitset 703 may not be within the minimum threshold distance of the Country A bitset 701 or within a minimum threshold distance of each other and, accordingly, both the Country F bitset 705 and the Country D bitset 703 can be designated as their own respective cluster centers. Bitsets 706, 707 and 708 are closest in distance to the Country F bitset 705 and, therefore, are clustered together with the Country F bitset 705. Bitsets 706, 707 and 708 are encoded as sparse sets 714, 715 and 716 respectively with the Country F bitset 705 designated as the cluster center. Similarly, the Country E bitset 709 can be within the minimum threshold distance of the Country D bitset 703 and, accordingly, can be clustered with the Country D bitset 703. Because the Country E bitset 709 is identical to the Country D bitset 703, the sparse set 717 for Country E can simply contain a reference to the Country D bitset 703.

In some embodiments, the cluster centers and the sparse sets can be iterated over again by the clustering process. FIG. 7B illustrates the manner in which a second pass clustering can be implemented, according to various aspects of the present invention. Prior to performing a second pass, the clustering process can first deduplicate the resultant bitsets. Thereafter, the clustering process is executed again and all the deduplicated bitsets are iterated over again. As shown in FIG. 7B, during the second pass clustering process, the Country F bitset 705 (and the sparse sets 714, 715 and 716 included in the cluster) is clustered together with the Country A cluster and the difference between the Country A bitset 701 and the Country F bitset 705 is represented as a sparse set 723. The sparse set 723 can then be used with the referenced cluster center, the Country A bitset 701, to extract the full Country F bitset 705. Similarly, the Country D bitset 703 can also be clustered using the Country A bitset 701 as the cluster center and represented as a sparse set 728. The sparse set 728 can be used with the cluster center, the Country A bitset 701, to extract the full Country D bitset 703.

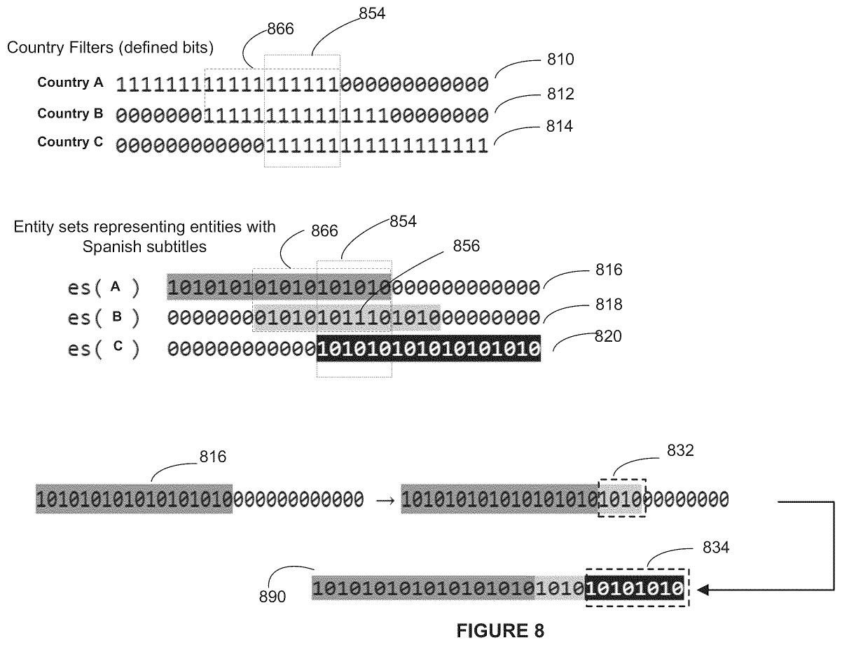

FIG. 8 is an example illustration of an advanced clustering process that can be applied to a set of related predicate sets computed across members of a group where each member is associated with a different set of available titles, according to various aspects of the present invention. As noted above, in some embodiments, each country-specific predicate set can be grouped together with related predicate sets across several countries and the clustering process can execute on all members of that group. For example, predicate sets for movies with Spanish subtitles for each respective country (from a possible set of, for example, 250 countries) can be grouped together and the clustering process can be executed across all the members of that group.

One of the challenges that arises in performing clustering for related predicate sets across different countries is that not every video exists in every country. Because of licensing and other considerations, each country may have access to a slightly different set of titles available for viewing. Consequently, the distance computation between predicate sets for each country can be skewed because of the differences in the available titles. For example, barring a few differences, the predicate sets for the list of movies with Spanish subtitles is expected to be fairly similar across all the countries. Accordingly, it is to be expected that the distance value between a predicate set representing movies with Spanish subtitles in Country A and a predicate set representing movies with Spanish subtitles in Country B will be relatively low. However, if there are significant differences between the set of titles available in Country A. and Country B, using the entire predicate set associated with movies with Spanish subtitles for Country A and Country B to perform the distance computation can produce an excessively high result, which is not representative of the differences between the set of commonly available entities with Spanish subtitles between the two countries. Not taking into account the differences in the sets of available titles for each country will result in large differences across all countries for related predicate sets (even though the differences between the commonly available titles in the predicate sets may be low).

In some embodiments, a normalization procedure needs to be conducted to reduce the effect of such skewing when performing the distance computation. In order to compute a more accurate distance value only the commonly defined bits between the predicate sets are used when performing the distance computation. In order to determine commonly defined bits, the set of titles that exist in each country are first defined as base country filter sets. As shown in FIG. 8, for example, the country filter (or the set of defined bits) for Country A is represented by the predicate set 810. Similarly, predicate set 812 represents the set of defined bits for Country B while predicate set 814 represents the set of defined bits for Country C. The commonly defined bits between Country A and Country B are represented by the box 866 while the commonly defined bits between Country A and Country C (and Country B) are represented by the box 854.

Using the country filters, a more accurate distance computation can be performed for a given set of predicates. As shown in FIG. 8, a given set of predicate sets 816, 818 and 820 may relate to the set of titles with Spanish subtitles in Country A, Country B and Country C, respectively. In order to execute a clustering process on this set of predicate sets, a distance computation needs to be performed. As mentioned above, a distance computation performed using the entire bitsets associated with predicate sets 816, 818 and 820 would be inaccurate because each country has a different set of available (or defined) titles. It should be noted that the defined bits for each of the predicate sets 816, 818 and 820 are distinguished from the undefined bits using highlighting in FIG. 8. Accordingly, in order to perform a more precise distance computation, only the mutually defined bits are taken into account when performing the distance computation to determine whether a predicate set can be clustered with a given cluster center.

As explained earlier in connection with FIG. 6B, the clustering process first starts with an empty cluster center list. The Country A predicate set 816 can be selected as the cluster center at the outset. Note that this selection can be based on a number of different criteria, including, random selection, designating a first predicate set in the list as the cluster center, or some other type of optimization criteria. Thereafter, the clustering process can select the Country B predicate set 818 and determine a distance between the Country A predicate set 816 and the Country B predicate set 818 using only the mutually defined bits between both predicate sets. As noted above, the commonly defined bits between Country A and Country B are represented by the box 866 while the commonly defined bits between Country A and Country C (and Country B) are represented by the box 854. The distance computation between the mutually defined bits in the Country A and Country B bitsets (as represented by the box 866) results in a value of 1 because only the bit at bit position 856 is different between the two sets. Accordingly, the Country B predicate set 818 can be clustered with the Country A predicate set 816 and represented using a reference to the cluster center and a sparse set that includes the flip bit associated with bit position 856. The formula for computing a distance between two partially defined sets can be represented as follows: (Aₛₑₜ XOR Bₛₑₜ) AND (A_{defined} AND B_{defined}), where the subscript “set” represents the set bits in a predicate set (e.g., representing titles with Spanish subtitles) and the subscript “defined” represents the defined bits in the predicate set (e.g., bits set in the country filters).

When a new member is added to the cluster, the advanced clustering process of FIG. 8 also involves augmenting the cluster center with bits from the predicate set being added to the cluster that were not defined in the predicate set that was initially chosen as the cluster center. In other words, an additional step in the advanced clustering process of FIG. 8 (as compared with the more basic clustering process discussed in connection with FIG. 6B) is that when a predicate set needs to be added to the cluster, the bits from that new member of the cluster that were not defined in the cluster center need to be added back in to the cluster center. For example, referencing the example in FIG. 8 again, when the Country B predicate set 818 needs to be added to the cluster (where the Country A predicate set 816 is the cluster center), the bits represented by box 832 in FIG. 8 need to be added to the original cluster center. Accordingly, as shown in FIG. 8, adding the Country B predicate set involves adding bits shown in box 832, which are undefined in the Country A predicate set (or country filter) 810, to the Country A predicate set 816.

Thereafter, the clustering process moves to the Country C predicate set 820. The distance between the mutually defined bits between the Country A predicate set 816 and the Country C predicate set 820 is zero because they are identical. Accordingly, the Country C predicate set 820 can also be clustered with the Country A predicate set 816. Again, adding the Country C predicate set 820 to the cluster involves adding the bits from the Country C predicate set 820 that were undefined in the Country A predicate set 816 to the cluster center. As shown in FIG. 8, the bits in box 834 represent bits in the Country C predicate set 820 that were not previously defined in the Country A predicate set 816. Accordingly, as new predicate sets get added to the cluster, the cluster center changes. As shown in FIG. 8, after the addition of bits shown in box 832 and bits shown in box 834, the final cluster center 890 is not identical to a predicate set associated with any one country. In fact, while the cluster center can start out identical to a particular country's predicate set (e.g., the cluster center in FIG. 8 is initially identical to the Country A predicate set 816), the cluster center evolves as new predicate sets get added to the cluster (e.g., the final cluster center 890 is a combination of the Country A predicate set 816 and bits from the Country B and Country C predicate sets that were previously undefined in the Country A predicate set). In this way, embodiments of the present disclosure keep the distance calculation valid for all of the previously discovered cluster members (since bits undefined in the previously discovered cluster members are not considered for the distance computation), and the newly added cluster members (the newly-defined bits are exactly equal to the set bits).

In some embodiments, in order to be able to reconstruct the original predicate set, the referenced cluster center is used along with the sparse set to XOR the flip bits in the referenced cluster. Thereafter, an intersection (an AND operation) is performed between the resultant set and the respective country filter associated with the predicate set being reconstructed in order to recreate the original predicate set. Referencing the example in FIG. 8 again, to reconstruct the Country B predicate set 818 using the cluster center 890, first, a sparse set for the Country B predicate set that identifies the bit positions that are flipped with respect to the cluster center (e.g., bit position 856) is used to perform one or more XOR operations with the cluster center 890 in order to compute the bits that are different from the cluster center. Thereafter, to obtain the bits defined exclusively for Country B, the resultant bitset is AND-ed with the Country B predicate set (or country filter) 812.

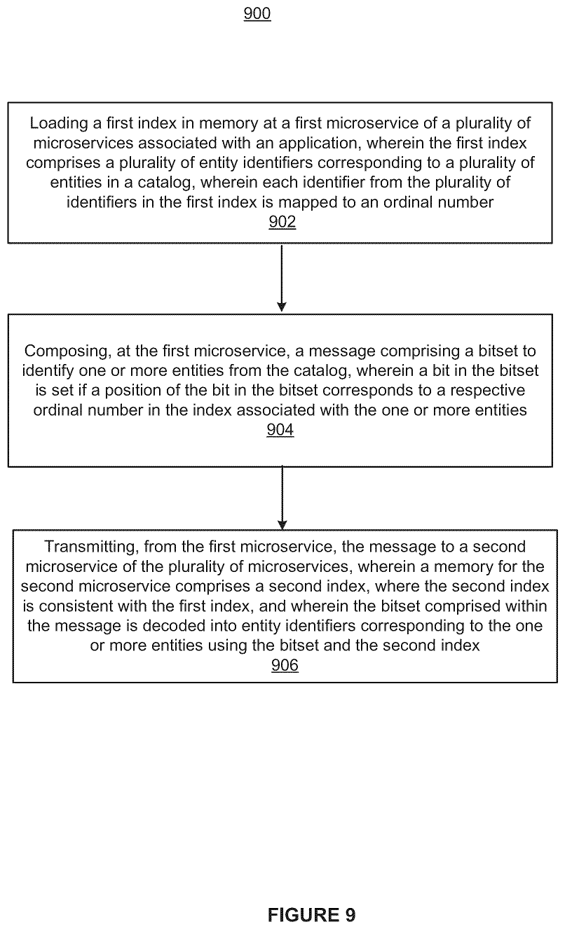

FIG. 9 is a flow diagram of method steps for transmitting messages pertaining to entities in a catalog using bitsets, according to various embodiments of the present invention. Although the method steps are described with reference to the systems of FIGS. 1-8, persons skilled in the art will understand that any system configured to implement the method steps, in any order, falls within the scope of the present invention.

As shown, a method 900 begins at step 902, where a first index 117(2) is loaded in memory at a first microservice (e.g., service A 130) associated with an application (e.g., an application associated with a content provider or streaming platform). In some embodiments, the first index 117(2) comprises a plurality of entity identifiers (e.g., entity identifier 208 as shown in FIG. 2) corresponding to a plurality of entities in a catalog, where each identifier from the plurality of identifiers in the index is mapped to an ordinal number (e.g., ordinal number 206 in FIG. 2).

At step 904, a message is composed at the first microservice that comprises a bitset to identify one or more entities from the catalog, wherein a bit in the bitset is set if a position of the bit in the bitset corresponds to a respective ordinal number in the index associated with the one or more entities.

At step 906, the message is transmitted from the first microservice to a second microservice 140 (e.g., service B) of the plurality of microservices, wherein a memory for the second microservice comprises a second index 117(3), where the second index is consistent with the first index, and wherein the bitset comprised within the message is decoded into entity identifiers corresponding to the one or more entities using the bitset and the second index.

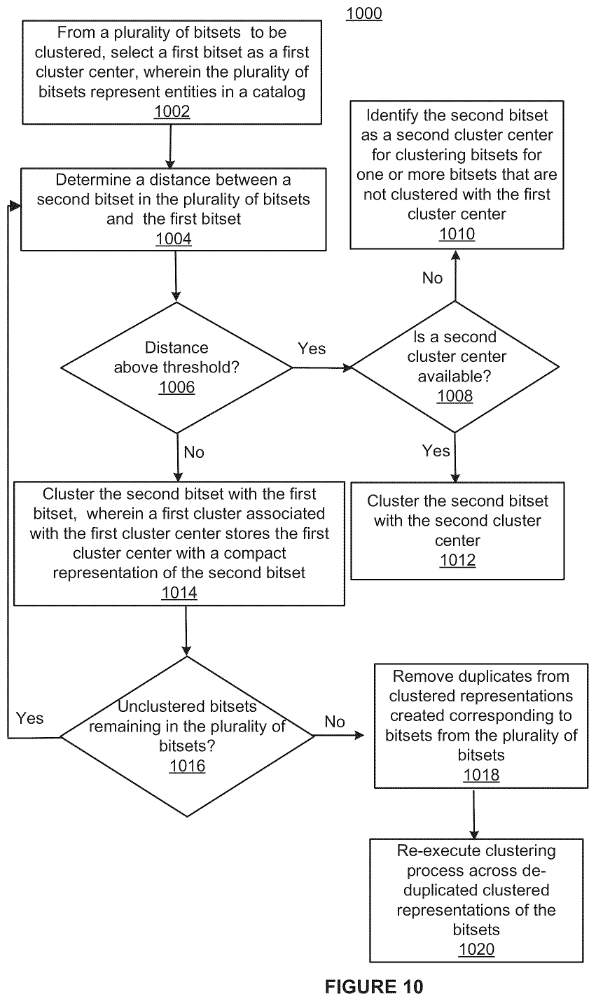

FIG. 10 is a flow diagram of method steps for clustering a group of bitsets, according to various embodiments of the present invention. Although the method steps are described with reference to the systems of FIGS. 1-8, persons skilled in the art will understand that any system configured to implement the method steps, in any order, falls within the scope of the present invention.

As shown, a method 1000 begins at step 1002, where from a plurality of bitsets (e.g., bitsets 612, 614, 616, 618 and 620 in FIG. 6B) to be clustered, a first bitset (e.g., bitset 612 in FIG. 6B) is selected as a first cluster center, where the plurality of bitsets represents entities in a catalog.

At step 1004, a distance is determined between a second bitset (e.g., bitset B 614) in the plurality of bitsets and the first bitset (e.g., bitset A 612).

At step 1006, the distance is compared to a minimum threshold distance, e.g., a predefined or predetermined threshold. Responsive to a determination that the distance is above the predefined threshold, it is determined that the second bitset cannot be clustered with the first bitset. For example, referencing FIG. 6B, bitset B 614 cannot be clustered with bitset A 612 because the distance between the two bitsets is above a minimum threshold. Thereafter, the clustering process at step 1008 determines if there is a second cluster center available with which to compare the second bitset. For example, referencing FIG. 6B again, when bitset B 614 cannot be clustered with bitset A 612, the clustering process attempts to find another cluster center with which to cluster bitset B 614.

At step 1008, responsive to a determination that a second cluster center is unavailable, the cluster process proceeds to step 1010, where the second bitset is identified as a second cluster center for clustering bitsets from the plurality of bitsets that are not clustered with the first cluster center. For example, referencing FIG. 6B again, when the clustering process does not find any other cluster centers with which to cluster bitset B 614, bitset B 614 is nominated as a new cluster center. Thereafter, bitsets 618 and 620 are clustered together using bitset B 614 as the cluster center. At step 1008, responsive to a determination that a second cluster center is available, the clustering process proceeds to step 1012, where the second bitset is clustered with the second cluster (provided that the distance between the second bitset and the second cluster is below the designated threshold).

Referencing step 1006 again, responsive to a determination that the distance is below the threshold, the method proceeds to step 1014, where the second bitset is clustered with the first bitset. In some embodiments, a first cluster that is associated with the first cluster center stores the first cluster center along with a compact representation of the second bitset. As discussed in connection with FIGS. 6A and 6B, a cluster can comprise a cluster center (e.g., cluster center bitset A 603 in FIG. 6A) along with one or more sparse sets for other bitsets clustered with the cluster center (e.g., sparse set B 608).

At step 1016, responsive to a determination that other unclustered bitsets remain in the plurality of bitsets, the clustering process selects a new bitset as the “second bitset” and re-executes the clustering process starting at step 1004. At step 1016, responsive to a determination that no unclustered bits remain in the plurality of bitsets, the cluster process proceeds to step 1018, where duplicates are removed from the clustered representations that are created corresponding to the bitsets from the plurality of bitsets.

At step 1020, the clustering process can be re-executed across the de-duplicated clustered representations of the bitsets. As shown in FIG. 7B, the clustering process can be re-executed, where the second pass clustering process may cluster together cluster centers that were previously in separate clusters.

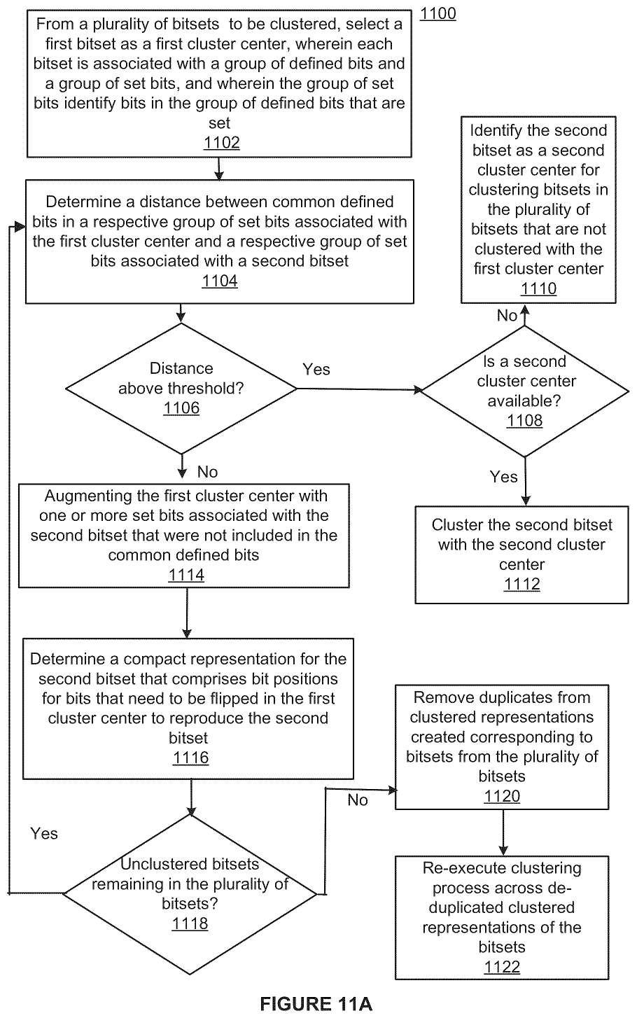

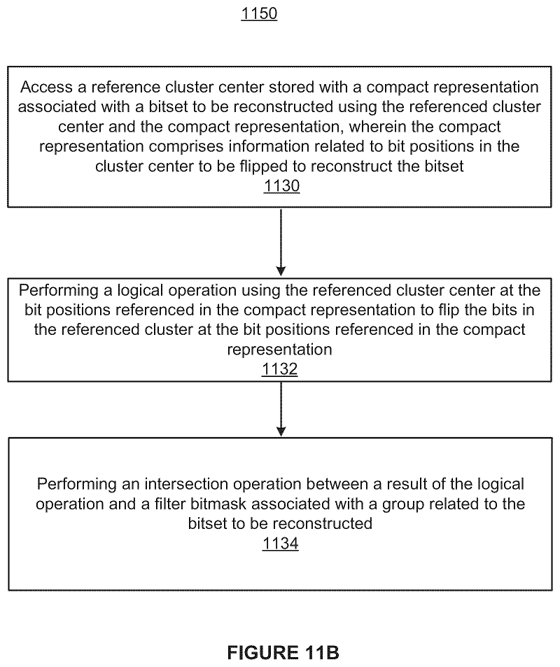

FIG. 11A is a flow diagram of method steps for clustering a group of bitsets computed across members of a group where each member is associated with a different set of available entities, according to various embodiments of the present invention. Although the method steps are described with reference to the systems of FIGS. 1-8, persons skilled in the art will understand that any system configured to implement the method steps, in any order, falls within the scope of the present invention.

As shown, a method 1100 begins at step 1102, where from a plurality of bitsets (e.g., predicate sets 816, 818 and 820 in FIG. 8) to be clustered, a first bitset (e.g., predicate set 816 in FIG. 8) is selected as a first cluster center, where each bitset is associated with a group of defined bits and a group of set bits, and where the group of set bits identify bits in the group of defined bits that are set. For example, referring to FIG. 8, each predicate set is associated with a group of set bits (e.g. predicate sets 816, 818 and 820) and a group of defined bits (e.g., predicate sets 810, 812 and 814) where each of the set bitsets corresponds to a defined bitset (also referred to in FIG. 8 as a country filter).

At step 1104, a distance is determined between common defined bits in a respective group of set bits associated with the first cluster center (which is initially identical to the first bitset) and a respective group of set bits associated with a second bitset. For example, referring to FIG. 8, a distance computation is performed between predicate set 816 and predicate set 818 between common defined bits (represented using box 866) from both bitsets.

At step 1106, the distance is compared to a minimum threshold distance, e.g. a predetermined or predefined threshold. Responsive to a determination that the distance is above the threshold, it is determined that the second bitset cannot be clustered with the first bitset. Thereafter, the clustering process at step 1108 determines if there is a second cluster center available with which to compare the second bitset. Responsive to a determination that a second cluster center is not available, the clustering process proceeds to step 1110, where the second bitset is identified (or nominated) as a second cluster center for clustering bitsets from the plurality of bitsets that are not clustered with the first cluster center. At step 1108, responsive to a determination that a second cluster center is available, the clustering process proceeds to step 1112, where the second bitset is clustered with the second cluster (provided that the distance between the second bitset and the second cluster is below the designated threshold).

Referencing step 1106 again, responsive to a determination that the distance is above the threshold, the cluster process proceeds to step 1114, where the first cluster center is augmented with a respective group of one or more set bits associated with the second bitset that were not included in the commonly defined bits. For example, referencing the example in FIG. 8 again, when the Country B predicate set 818 needs to be added to the cluster (where the Country A predicate set 816 is the cluster center), the bits represented by box 832 in FIG. 8, which were not part of the commonly defined bits represented by box 866, need to be added to the original cluster center.

At step 1116, a compact representation for the second bitset is determined, where the compact representation comprises bit positions for bits that need to be flipped in the first cluster center to reproduce the second bitset (e.g., as discussed in connection with FIG. 6A).

At step 1118, responsive to a determination that other unclustered bitsets remain in the plurality of bitsets, the clustering process selects a new bitset as the “second bitset” and re-executes the clustering process starting at step 1104. Responsive to a determination that no unclustered bits remain in the plurality of bitsets, at step 1120 duplicates are removed from the clustered representations that are created corresponding to the bitsets from the plurality of bitsets. At step 1122, the clustering process can be re-executed across the de-duplicated clustered representations of the bitsets.

FIG. 11B is a flow diagram of method steps for reconstructing a bitset from a compact representation created by the method discussed in connection with FIG. 11A, according to various embodiments of the present invention. Although the method steps are described with reference to the systems of FIGS. 1-8, persons skilled in the art will understand that any system configured to implement the method steps, in any order, falls within the scope of the present invention.

As shown, a method 1150 begins at step 1130, where a reference cluster center stored with a compact representation associated with a bitset to be reconstructed is accessed. The compact representation (e.g., sparse set B 608 in FIG. 6A) comprises information related to bit positions in the cluster center to be flipped to reconstruct the bitset.

At step 1132, a logical operation (e.g., an XOR operation) is performed on the referenced cluster center at the bit positions referenced in the compact representation to flip the bits in the referenced cluster at the bit positions referenced in the compact representation.

At step 1134, an intersection operation is performed between a result of the logical operation and a filter bitmask associated with a group related to the bitset to be reconstructed. For example, as discussed in connection with FIG. 8, after performing a logical operation to flip the bit in bit position 856 in the cluster center 890, an intersection (or AND) operation is performed between the resultant bitset and the predicate set 812 (the Country B country filter) to obtain the set of titles with Spanish subtitles in Country B.

FIG. 12 is a block diagram of a server 1210 that may be implemented in conjunction with system 100 of FIG. 1, according to various embodiments of the present invention. Each of the services 112, 130 and 140 can be implemented on or across one or more of the servers 1210 shown in FIG. 12. As shown, the server 1210 includes, without limitation, a central processing unit (CPU) 1204, a system disk 1206, an input/output (I/O) devices interface 1208, a network interface 1211, an interconnect 1212, and a system memory 1214.

The CPU 1204 is configured to retrieve and execute programming instructions, such as server application 1217, stored in the system memory 1214. Similarly, the CPU 1204 is configured to store application data (e.g., software libraries) and retrieve application data from the system memory 1214. The interconnect 1212 is configured to facilitate transmission of data, such as programming instructions and application data, between the CPU 1204, the system disk 1206, I/O devices interface 1208, the network interface 1211, and the system memory 1214. The I/O devices interface 1208 is configured to receive input data from I/O devices 1216 and transmit the input data to the CPU 1204 via the interconnect 1212. For example, I/O devices 1216 may include one or more buttons, a keyboard, a mouse, and/or other input devices. The I/O devices interface 1208 is further configured to receive output data from the CPU 1204 via the interconnect 1212 and transmit the output data to the I/O devices 1216.

The system disk 1206 may include one or more hard disk drives, solid state storage devices, or similar storage devices. The system disk 1206 is configured to store a database 1218 of information (e.g., the system disk 1206 can store a non-volatile copy of the entity index that is loaded into the memory 1214 on system startup).

In some embodiments, the network interface 1211 is configured to operate in compliance with the Ethernet standard.

The system memory 1214 includes a server application 1217. For example, when the server application 1217 receives a query, the server application 1217, in some embodiments, can determine a response to the query using predicate bitsets also stored in the memory 1214. Also the server application 1217 can access an entity index also stored in the memory 1214 to decode a bitset. For explanatory purposes only, each server application 1217 is described as residing in the memory 1214 and executing on the CPU 1204. In some embodiments, any number of instances of any number of software applications can reside in the memory 1214 and any number of other memories associated with any number of compute instances and execute on the CPU 1204 and any number of other processors associated with any number of other compute instances in any combination. In the same or other embodiments, the functionality of any number of software applications can be distributed across any number of other software applications that reside in the memory 1214 and any number of other memories associated with any number of other compute instances and execute on the processor 1210 and any number of other processors associated with any number of other compute instances in any combination. Further, subsets of the functionality of multiple software applications can be consolidated into a single software application.

In sum, the disclosed techniques may be used for communicating sets of entities in a content catalog. The method includes loading a first index into memory at a first microservice of a plurality of microservices associated with an application, wherein the first index comprises a plurality of entity identifiers corresponding to a plurality of entities in a catalog, wherein each identifier from the plurality of identifiers in the index is mapped to an ordinal number. The method also includes composing, at the first microservice, a message comprising a bitset to identify one or more entities from the catalog, wherein a bit in the bitset is set if a position of the bit in the bitset corresponds to a respective ordinal number in the index associated with the one or more entities. Additionally, the method includes transmitting, from the first microservice, the message to a second microservice of the plurality of microservices, wherein a memory for the second microservice comprises a second index, where the second index is a copy of and is consistent with the first index, and wherein the bitset comprised within the message is decoded into entity identifiers corresponding to the one or more entities using the bitset and the second index.

At least one technical advantage of the disclosed techniques relative to the prior art is that, with the disclosed techniques, the amount of time needed to transmit information (e.g., identifiers and other metadata) related to sets of titles or entities in a catalog is substantially reduced. In that regard, the disclosed techniques enable a user to represent a set of entities in a catalog using a bitset representation. Because each microservice in the application comprises an in-memory copy of an index that can be used to decode the bitset back into a set of identifiers associated with the set of entities, prohibitively large messages do not need to be exchanged between the microservices. Additionally, the entire catalog can be represented more efficiently using bitsets. Representing the entire catalog as bitsets not only reduces the size of the messages between services, but also the cost of constructing and interpreting the messages is significantly reduced.

Another advantage of the disclosed techniques is that because the catalog can be represented using bitsets, computations on the catalog can be performed using a fraction of the time (e.g., in sub-milliseconds) relative to prior art techniques. For example, complex query operations can be performed at the granularity of the entire content catalog using bitwise operations that can be performed over a single clock cycle. The disclosed techniques also allow for highly scalable remote queries across the entire catalog because the resultant bitsets have a low constant maximum size (regardless of the number of entities contained in the computational results of the queries) and can be transmitted rapidly and efficiently between microservices. Another advantage is that similarities in sets of predicate bitsets can be leveraged to cluster the bitsets and store them much more cheaply and efficiently relative to prior art techniques that did not use bitsets. These technical advantages provide one or more technological improvements over prior art approaches.

1. According to some embodiments, a computer-implemented method comprises loading a first index in memory at a first microservice of a plurality of microservices associated with an application, wherein the first index comprises a plurality of entity identifiers corresponding to a plurality of entities in a catalog, wherein each identifier from the plurality of identifiers in the first index is mapped to an ordinal number; composing, at the first microservice, a message comprising a bitset to identify one or more entities from the catalog, wherein a given bit in the bitset is set if a position of the given bit in the bitset corresponds to a respective ordinal number in the index associated with the one or more entities; and transmitting, from the first microservice, the message to a second microservice of the plurality of microservices, wherein a memory for the second microservice comprises a second index, wherein the second index is consistent with the first index, and wherein the bitset is decoded into entity identifiers corresponding to the one or more entities using the second index.

2. The computer-implemented method according to clause 1, wherein the application is implemented in a cloud computing environment.

3. The computer-implemented method according to any of clauses 1-2, wherein the application is associated with a content streaming platform.

4. The computer-implemented method according to any of clauses 1-3, further comprising storing the bitset in memory at a computing device associated with the first microservice as a precomputed bitmask, wherein the one or more entities identified by the precomputed bitmask are referenced within the application on a recurring basis to perform computations related to the one more entities.

5. The computer-implemented method according to any of clauses 1-4, further comprising storing the bitset in memory at a computing device associated with the first microservice as a precomputed bitmask, wherein the one or more entities identified by the precomputed bitmask are referenced within the application on a recurring basis to perform computations related to the one more entities; and performing a logical computation between the precomputed bitmask and one or more other precomputed bitmasks in response to a query.

6. The computer-implemented method of claim according to any of clauses 1-5, further comprising receiving, at the first microservice, a plurality of precomputed bitmasks from a data storage service, wherein each of the plurality of precomputed bitmasks comprises a respective bitset associated with a category of entities in the catalog; receiving, at the first microservice, a query related to the catalog from the second microservice; responsive to the query, performing logical operations between one or more precomputed bitmasks to compute a result; and transmitting the result to the second microservice.

7. The computer-implemented method according to any of clauses 1-6, further comprising receiving, at the first microservice, a plurality of precomputed bitmasks from a data storage service, wherein each of the plurality precomputed bitmasks comprises a respective bitset associated with a category of entities in the catalog, and wherein a data storage service stores precomputed bitmasks uploaded from a computing device configured to compute and store precomputed bitmasks on a recurring basis; receiving, at the first microservice, a query related to the catalog; responsive to the query, performing logical operations, at the first microservice, between the bitset and at least one precomputed bitmask to compute a result; and transmitting the result of the logical operations.

8. The computer-implemented method according to any of clauses 1-7, wherein the first index is associated with a particular type of content in the catalog.

9. The computer-implemented method according to any of clauses 1-8, further comprising for an entity from the plurality of entities to be removed from the catalog, reserving a position for a respective entity identifier in the first index for a predetermined duration of time.

10. The computer-implemented method according to any of clauses 1-9, further comprising receiving, at the first microservice, a plurality of precomputed bitmasks from a data storage service, wherein one or more of the plurality of precomputed bitmasks are compressed using gap encoding, wherein the gap encoding comprises encoding a precomputed bitmask as a sparse set, wherein the sparse set encodes bit positions in the precomputed bitmask associated with set bits as integers; and decoding the one or more precomputed bitmasks prior to performing a computation using the one or more precomputed bitmasks.

11. The computer-implemented method according to any of clauses 1-10, wherein the bitset comprises a temporal entity set, and wherein the temporal entity set comprises a base bitset representing a state of the catalog at an initial time, one or more timestamps associated with times when a bit in the base bitset is expected to flip, and one or more bit positions for each timestamp corresponding to bits in the base bitset that are expected to flip.

12. According to some embodiments, one or more non-transitory computer-readable storage media include instructions that, when executed by a processor, cause the processor to perform the steps of loading a first index in memory at a first microservice of a plurality of microservices associated with an application, wherein the first index comprises a plurality of entity identifiers corresponding to a plurality of entities in a catalog, wherein each identifier from the plurality of identifiers in the first index is mapped to an ordinal number; composing, at the first microservice, a message comprising a bitset to identify one or more entities from the catalog, wherein a given bit in the bitset is set if a position of the given bit in the bitset corresponds to a respective ordinal number in the index associated with the one or more entities; and transmitting, from the first microservice, the message to a second microservice of the plurality of microservices, wherein a memory for the second microservice comprises a second index, wherein the second index is consistent with the first index, and wherein the bitset is decoded into entity identifiers corresponding to the one or more entities using the second index.

13. The non-transitory computer readable media according to clause 12, wherein the application is associated with a content streaming platform.

14. The non-transitory computer readable media according to any of clauses 12-13, further comprising storing the bitset in memory at a computing device associated with the first microservice as a precomputed bitmask, wherein the one or more entities identified by the precomputed bitmask are referenced within the application on a recurring basis to perform computations related to the one more entities.

15. The non-transitory computer readable media according to any of clauses 12-14, further comprising storing the bitset in memory at a computing device associated with the first microservice as a precomputed bitmask, wherein the one or more entities identified by the precomputed bitmask are referenced within the application on a recurring basis to perform computations related to the one more entities; and performing a logical computation between the precomputed bitmask and one or more other precomputed bitmasks in response to a query.

16. The non-transitory computer readable media according to any of clauses 12-15, further comprising for an entity from the plurality of entities to be removed from the catalog, reserving a position for a respective entity identifier in the first index for a predetermined duration of time.

17. The non-transitory computer readable media according to any of clauses 12-16, further comprising receiving, at the first microservice, a plurality of precomputed bitmasks from a data storage service, wherein one or more of the plurality of precomputed bitmasks are compressed using gap encoding, wherein the gap encoding comprises encoding a precomputed bitmask as a sparse set, wherein the sparse set encodes bit positions in the precomputed bitmask associated with set bits as integers; and decoding the one or more precomputed bitmasks prior to performing a computation using the one or more precomputed bitmasks.

18. According to some embodiments, a system comprises a memory storing a memory pool application; and a processor coupled to the memory, wherein when executed by the processor, the memory pool application causes the processor to load a first index in memory at a first microservice of a plurality of microservices associated with an application, wherein the first index comprises a plurality of entity identifiers corresponding to a plurality of entities in a catalog, wherein each identifier from the plurality of identifiers in the first index is mapped to an ordinal number; compose, at the first microservice, a message comprising a bitset to identify one or more entities from the catalog, wherein a given bit in the bitset is set if a position of the given bit in the bitset corresponds to a respective ordinal number in the index associated with the one or more entities; and transmit, from the first microservice, the message to a second microservice of the plurality of microservices, wherein a memory for the second microservice comprises a second index, wherein the second index is consistent with the first index, and wherein the bitset is decoded into entity identifiers corresponding to the one or more entities using the second index.

19. The system according to clause 18, wherein the bitset comprises a temporal entity set, and wherein the temporal entity set comprises a base bitset representing a state of the catalog at an initial time, one or more timestamps associated with times when a bit in the base bitset is expected to flip, and one or more bit positions for each timestamp corresponding to bits in the base bitset that are expected to flip.

20. The system according to clauses 18 and 19, wherein the first index is associated with a particular type of content in the catalog.

21. According to some embodiments, a computer-implemented method comprises from a plurality of bitsets to be clustered, selecting a first bitset as a first cluster center, wherein each bitset in the plurality of bitsets is associated with a group of defined bits and a group of set bits, and wherein the group of set bits identify bits in the group of defined bits that are set in a respective bitset; determining a distance between commonly defined bits in a respective group of set bits associated with the first cluster center and a respective group of set bits associated with a second bitset in the plurality of bitsets; determining that the distance is below a threshold; responsive to the determination, augmenting the first cluster center with one or more set bits in a respective group of set bits associated with the second bitset to create an augmented first cluster center; and determining a compact representation for the second bitset comprising bit positions for bits that need to be flipped in the augmented first cluster center to reconstruct the second bitset.

22. The computer-implemented method according to clause 21, wherein the one or more set bits used to augment the first cluster center comprise bits not included in the commonly defined bits.

23. The computer-implemented method according to any of clauses 21-22, further comprising determining whether an unclustered bitset remains in the plurality of bitsets; responsive to a determination that an unclustered bitset remains, cluster the unclustered bitset with the first cluster center responsive to a determination that a distance between the first cluster center and the unclustered bitset is below the predetermined threshold.

24. The computer-implemented method according to any of clauses 21-23, further comprising determining whether an unclustered bitset remains in the plurality of bitsets; responsive to a determination that no unclustered bitsets remain, remove duplicates from clustered representations created corresponding to the plurality of bitsets; and re-execute a clustering process for the clustered representations created corresponding to the plurality of bitsets.

25. The computer-implemented method according to any of clauses 21-24, further comprising responsive to a determination that the distance is above the predetermined threshold, determine whether a second cluster center is available; responsive to a determination that a second cluster center is available, cluster the second bitset with the second cluster center responsive to a determination that the distance between the second bitset and the second cluster center is below the predetermined threshold.

26. The computer-implemented method according to any of clauses 21-25, further comprising responsive to a determination that the distance is above the predetermined threshold, determine whether a second cluster center is available; and responsive to a determination that a second cluster center is not available, nominate the second bitset as a second cluster for clustering bitsets in the plurality of bitsets that are not clustered with the first cluster center.

27. The computer-implemented method according to any of clauses 21-26, wherein each of the plurality of bitsets represent titles related to a particular category that are available in a catalog for a particular country.

28. The computer-implemented method according to any of clauses 21-27, wherein each of the plurality of bitsets represent titles related to a particular category that are available in a catalog for a particular country, and wherein a respective group of defined bits for a bitset comprises a precomputed bitmask representing available titles for a respective country.

29. The computer-implemented method according to any of clauses 21-28, further comprising reconstructing the second bitset from the compact representation, wherein reconstructing the second bitset comprises accessing the augmented first cluster center; performing a logical operation on the augmented first cluster center to flip bits associated with the bit positions stored in the compact representation for the second bitset; and performing a logical intersection between a result of the logical operation and a respective group of defined bits associated with the second bitset.

30. The computer-implemented method according to any of clauses 21-29, wherein the logical operation comprises an XOR operation.

31. According to some embodiments, one or more non-transitory computer-readable storage media includes instructions that, when executed by a processor, cause the processor to perform the steps of from a plurality of bitsets to be clustered, selecting a first bitset as a first cluster center, wherein each bitset in the plurality of bitsets is associated with a group of defined bits and a group of set bits, and wherein the group of set bits identify bits in the group of defined bits that are set in a respective bitset; determining a distance between commonly defined bits in a respective group of set bits associated with the first cluster center and a respective group of set bits associated with a second bitset in the plurality of bitsets; determining that the distance is below a threshold; responsive to the determination, augmenting the first cluster center with one or more set bits in a respective group of set bits associated with the second bitset to create an augmented first cluster center; and determining a compact representation for the second bitset comprising bit positions for bits that need to be flipped in the augmented first cluster center to reconstruct the second bitset.

32. The non-transitory computer readable media according to clause 31, wherein the one or more set bits used to augment the first cluster center comprise bits not included in the commonly defined bits.

33. The non-transitory computer readable media according to any of clauses 31-32, further comprising determining whether an unclustered bitset remains in the plurality of bitsets; responsive to a determination that an unclustered bitset remains, cluster the unclustered bitset with the first cluster center responsive to a determination that a distance between the first cluster center and the unclustered bitset is below the predetermined threshold.

34. The non-transitory computer readable media according to any of clauses 31-33, further comprising determining whether an unclustered bitset remains in the plurality of bitsets; responsive to a determination that no unclustered bitsets remain, remove duplicates from clustered representations created corresponding to the plurality of bitsets; and re-execute a clustering process for the clustered representations created corresponding to the plurality of bitsets.

35. The non-transitory computer readable media according to any of clauses 31-34, further comprising responsive to a determination that the distance is above the predetermined threshold, determine whether a second cluster center is available; responsive to a determination that a second cluster center is available, cluster the second bitset with the second cluster center responsive to a determination that the distance between the second bitset and the second cluster center is below the predetermined threshold.

36. The non-transitory computer readable media according to any of clauses 31-35, further comprising responsive to a determination that the distance is above the predetermined threshold, determine whether a second cluster center is available; and responsive to a determination that a second cluster center is not available, nominate the second bitset as a second cluster for clustering bitsets in the plurality of bitsets that are not clustered with the first cluster center.

37. The non-transitory computer readable media according to any of clauses 31-36, wherein each of the plurality of bitsets represent titles related to a particular category that are available in a catalog for a particular country.

38. The non-transitory computer readable media according to any of clauses 31-37, wherein each of the plurality of bitsets represent titles related to a particular category that are available in a catalog for a particular country, and wherein a respective group of defined bits for a bitset comprises a precomputed bitmask representing available titles for a respective country.

39. A system comprising: a memory storing a memory pool application; and a processor coupled to the memory, wherein when executed by the processor, the memory pool application causes the processor to: from a plurality of bitsets to be clustered, select a first bitset as a first cluster center, wherein each bitset in the plurality of bitsets is associated with a group of defined bits and a group of set bits, and wherein the group of set bits identify bits in the group of defined bits that are set in a respective bitset; determine a distance between commonly defined bits in a respective group of set bits associated with the first cluster center and a respective group of set bits associated with a second bitset in the plurality of bitsets; determine that the distance is below a threshold; responsive to the determination, augment the first cluster center with one or more set bits in a respective group of set bits associated with the second bitset to create an augmented first cluster center; and determine a compact representation for the second bitset comprising bit positions for bits that need to be flipped in the augmented first cluster center to reconstruct the second bitset.

40. The system according to clause 39, wherein each of the plurality of bitsets represent titles related to a particular category that are available in a catalog for a particular country.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
loading a first index in memory at a first microservice of a plurality of microservices associated with an application, wherein the first index comprises a plurality of entity identifiers corresponding to a plurality of entities in a catalog, wherein each identifier from the plurality of identifiers in the first index is mapped to an ordinal number;
composing, at the first microservice, a message comprising a bitset to identify one or more entities from the catalog, wherein a given bit in the bitset is set if a position of the given bit in the bitset corresponds to a respective ordinal number in the index associated with the one or more entities; and
transmitting, from the first microservice, the message to a second microservice of the plurality of microservices, wherein a memory for the second microservice comprises a second index, wherein the second index is consistent with the first index, and wherein the bitset is decoded into entity identifiers corresponding to the one or more entities using the second index.

2. The computer-implemented method of claim 1, wherein the application is implemented in a cloud computing environment.

3. The computer-implemented method of claim 1, wherein the application is associated with a content streaming platform.

4. The computer-implemented method of claim 1, further comprising:
storing the bitset in memory at a computing device associated with the first microservice as a precomputed bitmask, wherein the one or more entities identified by the precomputed bitmask are referenced within the application on a recurring basis to perform computations related to the one more entities.

5. The computer-implemented method of claim 1, further comprising:
storing the bitset in memory at a computing device associated with the first microservice as a precomputed bitmask, wherein the one or more entities identified by the precomputed bitmask are referenced within the application on a recurring basis to perform computations related to the one more entities; and
performing a logical computation between the precomputed bitmask and one or more other precomputed bitmasks in response to a query.

6. The computer-implemented method of claim 1, further comprising:
receiving, at the first microservice, a plurality of precomputed bitmasks from a data storage service, wherein each of the plurality of precomputed bitmasks comprises a respective bitset associated with a category of entities in the catalog;
receiving, at the first microservice, a query related to the catalog from the second microservice;
responsive to the query, performing logical operations between one or more precomputed bitmasks to compute a result; and
transmitting the result to the second microservice.

7. The computer-implemented method of claim 1, further comprising:
receiving, at the first microservice, a plurality of precomputed bitmasks from a data storage service, wherein each of the plurality precomputed bitmasks comprises a respective bitset associated with a category of entities in the catalog, and wherein a data storage service stores precomputed bitmasks uploaded from a computing device configured to compute and store precomputed bitmasks on a recurring basis;
receiving, at the first microservice, a query related to the catalog;
responsive to the query, performing logical operations, at the first microservice, between the bitset and at least one precomputed bitmask to compute a result; and
transmitting the result of the logical operations.

8. The computer-implemented method of claim 1, wherein the first index is associated with a particular type of content in the catalog.

9. The computer-implemented method of claim 1, further comprising:
for an entity from the plurality of entities to be removed from the catalog, reserving a position for a respective entity identifier in the first index for a predetermined duration of time.

10. The computer-implemented method of claim 1, further comprising:
receiving, at the first microservice, a plurality of precomputed bitmasks from a data storage service, wherein one or more of the plurality of precomputed bitmasks are compressed using gap encoding, wherein the gap encoding comprises encoding a precomputed bitmask as a sparse set, wherein the sparse set encodes bit positions in the precomputed bitmask associated with set bits as integers; and
decoding the one or more precomputed bitmasks prior to performing a computation using the one or more precomputed bitmasks.

11. The computer-implemented method of claim 1, wherein the bitset comprises a temporal entity set, and wherein the temporal entity set comprises a base bitset representing a state of the catalog at an initial time, one or more timestamps associated with times when a bit in the base bitset is expected to flip, and one or more bit positions for each timestamp corresponding to bits in the base bitset that are expected to flip.

12. A non-transitory computer-readable storage medium including instructions that, when executed by a processor, cause the processor to perform the steps of:
loading a first index in memory at a first microservice of a plurality of microservices associated with an application, wherein the first index comprises a plurality of entity identifiers corresponding to a plurality of entities in a catalog, wherein each identifier from the plurality of identifiers in the first index is mapped to an ordinal number;
composing, at the first microservice, a message comprising a bitset to identify one or more entities from the catalog, wherein a given bit in the bitset is set if a position of the given bit in the bitset corresponds to a respective ordinal number in the index associated with the one or more entities; and
transmitting, from the first microservice, the message to a second microservice of the plurality of microservices, wherein a memory for the second microservice comprises a second index, wherein the second index is consistent with the first index, and wherein the bitset is decoded into entity identifiers corresponding to the one or more entities using the second index.

13. The non-transitory computer readable media of claim 12, wherein the application is associated with a content streaming platform.

14. The non-transitory computer readable media of claim 12, further comprising:
storing the bitset in memory at a computing device associated with the first microservice as a precomputed bitmask, wherein the one or more entities identified by the precomputed bitmask are referenced within the application on a recurring basis to perform computations related to the one more entities.

15. The non-transitory computer readable media of claim 12, further comprising:
storing the bitset in memory at a computing device associated with the first microservice as a precomputed bitmask, wherein the one or more entities identified by the precomputed bitmask are referenced within the application on a recurring basis to perform computations related to the one more entities; and
performing a logical computation between the precomputed bitmask and one or more other precomputed bitmasks in response to a query.

16. The non-transitory computer readable media of claim 12, further comprising:
for an entity from the plurality of entities to be removed from the catalog, reserving a position for a respective entity identifier in the first index for a predetermined duration of time.

17. The non-transitory computer readable media of claim 12, further comprising:
receiving, at the first microservice, a plurality of precomputed bitmasks from a data storage service, wherein one or more of the plurality of precomputed bitmasks are compressed using gap encoding, wherein the gap encoding comprises encoding a precomputed bitmask as a sparse set, wherein the sparse set encodes bit positions in the precomputed bitmask associated with set bits as integers; and
decoding the one or more precomputed bitmasks prior to performing a computation using the one or more precomputed bitmasks.

18. A system comprising:
a memory storing a memory pool application; and
a processor coupled to the memory, wherein when executed by the processor, the memory pool application causes the processor to:
load a first index in memory at a first microservice of a plurality of microservices associated with an application, wherein the first index comprises a plurality of entity identifiers corresponding to a plurality of entities in a catalog, wherein each identifier from the plurality of identifiers in the first index is mapped to an ordinal number;
compose, at the first microservice, a message comprising a bitset to identify one or more entities from the catalog, wherein a given bit in the bitset is set if a position of the given bit in the bitset corresponds to a respective ordinal number in the index associated with the one or more entities; and
transmit, from the first microservice, the message to a second microservice of the plurality of microservices, wherein a memory for the second microservice comprises a second index, wherein the second index is consistent with the first index, and wherein the bitset is decoded into entity identifiers corresponding to the one or more entities using the second index.

19. The system of claim 18, wherein the bitset comprises a temporal entity set, and wherein the temporal entity set comprises a base bitset representing a state of the catalog at an initial time, one or more timestamps associated with times when a bit in the base bitset is expected to flip, and one or more bit positions for each timestamp corresponding to bits in the base bitset that are expected to flip.

20. The system of claim 18, wherein the first index is associated with a particular type of content in the catalog.
